(19) United States
(12) Patent Application Publication
(10) Pub. No.: US 2025/0288988 A1
(43) Pub. Date: Sep. 18, 2025

(54) SYSTEMS AND METHODS FOR COVERING AND SEALING AN OPEN WELL

(71) Applicant: 10x Genomics, Inc., Pleasanton, CA (US)

(72) Inventors: Brenden Janatpour Brown, Castro Valley, CA (US); Yiran Zhang, Castro Valley, CA (US)

(21) Appl. No.: 19/079,767

(22) Filed: Mar. 14, 2025

Related U.S. Application Data
(60) Provisional application No. 63/565,701, filed on Mar. 15, 2024.

(51) Int. Cl. B01L 3/00

(52) U.S. Cl. CPC B01L 3/502; B01L 2200/02; B01L 2200/0689; B01L 2300/041

(57) ABSTRACT

A lid for forming a sealed fluidic chamber includes a cover having a planar outer surface and an inner surface separated from the planar outer surface by a thickness, and a skirt extending about a perimeter of the inner surface, where the skirt and the inner surface define a recess. The lid further includes a flange extending about a perimeter of the skirt, where the flange is parallel to the planar outer surface. The lid further includes a first crossbar and second crossbar extending parallel to the first and second side, respectively. The first crossbar and second crossbars have a first and second pair of snap joint elements, respectively.

### CROSS-REFERENCE TO RELATED APPLICATION

This application claims the benefit under 35 U.S.C. § 119(e) of U.S. Provisional App. No. 63/565,701, filed on Mar. 15, 2024, the entire contents of which are hereby incorporated by reference.

### FIELD

The present disclosure relates to a lid for covering and sealing an open well flow cell. Particularly, the present disclosure is directed to devices and assemblies including a stackable lid that is attachable to an open well flow cell formed by a cassette, glass slide, and gasket to thereby cover and seal the open well flow cell.

### BACKGROUND

Many biomedical applications rely on high-throughput assays of biological samples combined with one or more reagents using flow devices (e.g., open well flow cells and closed flow cells). For example, in both research and clinical applications, high-throughput assays using target-specific reagents for analyzing molecules present in a biological sample can provide information for various applications.

Cassette assemblies including a gasket and a glass slide (on which a sample is positioned) can be used to define an open well having a volume into which liquid can be dispensed or extracted for sample preparation and processing. However, the opening to the open well flow cell has a horizontal cross-sectional area that is generally equal to (or larger than) the horizontal cross-sectional area of the well (the area circumscribed by the sides of the well), which means that any liquid within the well is subject to evaporative loss over the exposed area. Placing PCR tape over the top of the well can prevent this loss but can also interact with the liquid depending on the volume and lead to dewetting effects. Moreover, PCR tape may not have enough sealing force capable of maintaining a sealed well throughout sample preparation.

Open well flow cells are generally preferable to closed flow cells when performing imaging of a biological sample (e.g., cell or tissue sample) disposed therein because imaging optics can be immersed in an immersion fluid contained within the open well and also because there is no material between the imaging optics and sample causing unwanted optical distortions (that would have to be corrected). Existing solutions for sealing an open well flow cell to form a sealed chamber utilize a sealing tape or other cover and place the same over an opening of the well. In most cases, the tape or cover is placed flush with the opening of the well. However, tape does not provide robust sealing of the open well flow cell because the tape does not provide a strong sealing force against the open well flow cell. Additionally, while other covers may include clips to provide improved sealing forces, the sealing forces induces bending that does not align with the bending of the open well flow cell, thus causing partial or failed sealing.

Accordingly, there exists a need for a device and assemblies for covering and sealing an open well flow cell that address at least the identified deficiencies.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods, assemblies and devices particularly pointed out in the written description and claims hereof, as well as from the appended drawings.

To achieve these and other advantages and in accordance with the purpose of the present disclosure, as embodied and broadly described, the disclosed subject matter includes a lid for forming a sealed fluidic chamber, the lid including a cover including a first side opposite a second side and a third side opposite a fourth side, wherein the first side and the second side each have a first length and the third side and the fourth side each have a second length, wherein the first length is greater than the second length a planar outer surface and an inner surface separated from the planar outer surface by a thickness of the cover, a skirt extending about a perimeter of the inner surface, the skirt and the inner surface define a recess, a flange extending about a perimeter of the skirt, the flange disposed parallel to the planar outer surface, a first crossbar extending parallel to the first side of the cover, the first crossbar having a first pair of snap joint elements, a second cross bar extending parallel to the second side of the cover, the second crossbar having a second pair of snap joint elements.

The disclosed subject matter also includes an assembly, including a sample device including a bottom portion and a top portion, wherein the bottom portion is releasably coupled to the top portion, a gap is formed between the bottom portion and the top portion when the bottom portion is coupled to the top portion, the gap configured to receive a sample substrate and the top portion including a well, the bottom portion including a plurality of snap joint receiving elements, at least a pair of the plurality of snap joint receiving elements arranged on the bottom portion substantially opposite from each other and a cover lid including a first side opposite a second side and a third side opposite a fourth side, wherein the first side and the second side each have a first length and the third side and the fourth side each have a second length, wherein the first length is greater than the second length, a planar outer surface and an inner surface separated from the planar outer surface by a thickness of the cover, a skirt extending about a perimeter of the inner surface, the skirt and the inner surface define a recess, a flange extending about a perimeter of the skirt, the flange disposed parallel to the planar outer surface, a first crossbar extending parallel to the first side of the cover, the first cross bar having a first pair of snap joint elements, a second cross bar extending parallel to the second side of the cover, the second cross bar having a second pair of snap joint elements, wherein when the lid engages with the sample device, the first and second pair of snap joint elements engage with a plurality of corresponding snap joint receiving elements to form a seal between the lid and a periphery of the well of the top portion.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIGS. 1A-1C are perspective, front and exploded schematic representations of cassette assembly having a stackable lid in accordance with the present disclosure.

FIG. 2 is a cross-sectional and side view of the cassette assembly having a stackable lid in accordance with the present disclosure.

FIG. 3 is a cross-sectional view of the assembly and a perspective view of the stackable lid in accordance with the present disclosure.

FIGS. 4A-4B are perspective and cross-sectional views of a cassette for use in an assembly with a stackable lid in accordance with the present disclosure.

FIG. 5 is a side-by-side representations of lid and cassette bowing with varying snap joint arrangements in accordance with the present disclosure.

FIG. 6A is a perspective view of a cassette assembly with a stackable lid in accordance with the present disclosure.

FIGS. 6B-6D are planform, exploded perspective and side views of assemblies on an adapter plate in accordance with the present disclosure.

FIG. 7 is a perspective and side view of a gasket having an O-ring element disposed in a well of a cassette in accordance with the present disclosure.

FIGS. 8A-8B are planform, cross-sectional views and perspective views of the top and bottom portions of the cassette in accordance with the present disclosure.

FIG. 9 is a cross-sectional view of the assembly showing O-ring style sealing between lid and gasket, and lid engaging bottom portion of sample device in accordance with the present disclosure.

FIGS. 10-11 are representations of stackable lids in accordance with the present disclosure.

FIGS. 12A-12B are perspective views of a stackable lid in accordance with the present disclosure.

FIGS. 12C-12D are a top view and a bottom view of a stackable lid, respectively, in accordance with the present disclosure.

FIGS. 12E-12H are side views of a stackable lid in accordance with the present disclosure.

### DETAILED DESCRIPTION

Reference will now be made in detail to exemplary embodiments of the present disclosure, an example of which is illustrated in the accompanying drawings. The method and corresponding steps of the present disclosure will be described in conjunction with the detailed description of the system.

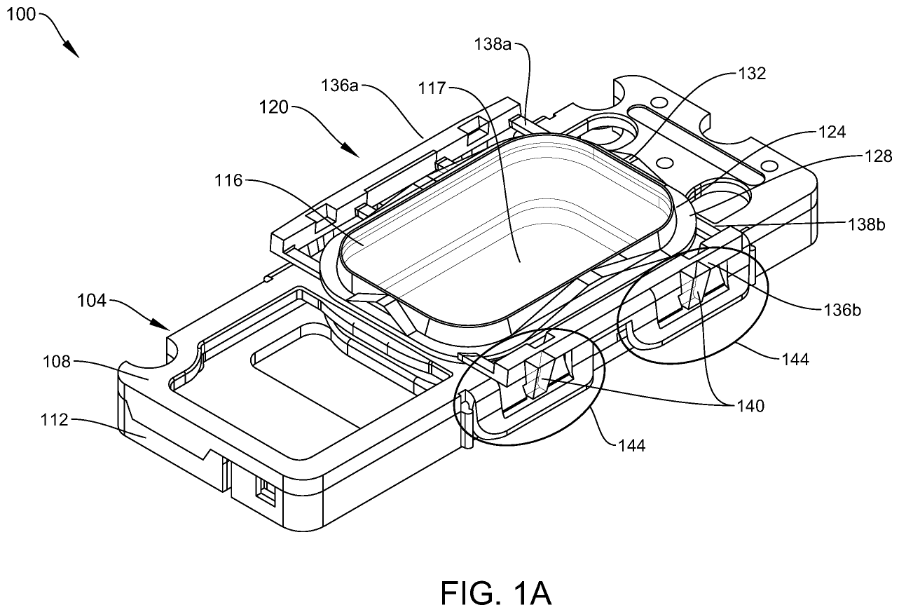

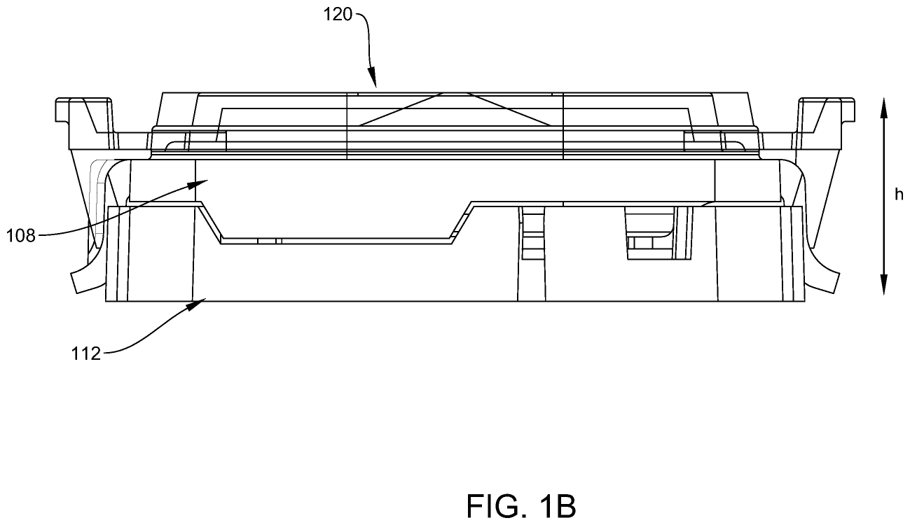

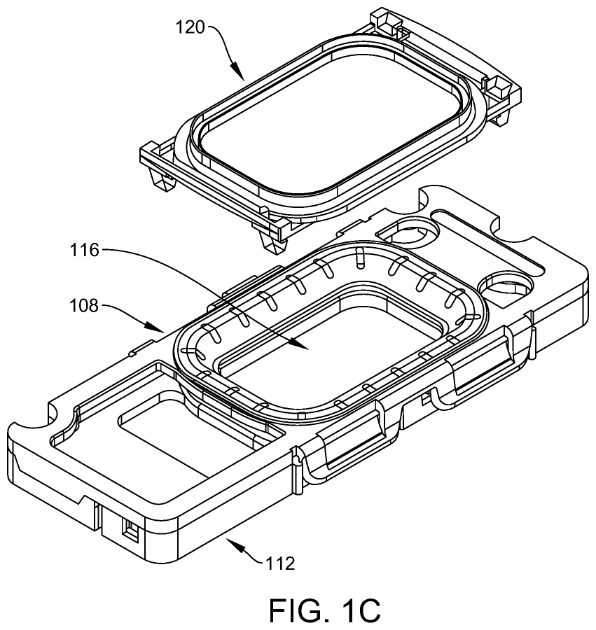

The methods, devices, and assemblies presented herein may be used for covering and sealing an open well flow cell. An “open well flow cell” may also be referred to simply as an “open well” and generally refers to any well or recess that is configured to receive a sample (e.g., a biological tissue or hydrogel) and receive and hold at least a predetermined volume of liquid (e.g., one or more reagents, such as fluorescently tagged oligonucleotides, fluorescently tagged nucleotides, or an imaging buffer for improved microscopy resolution and/or keeping the sample hydrated during imaging) therein. An open well flow cell may be formed by aligning a cassette (e.g., upper and lower halves) over a substrate (e.g., a glass slide). The open well flow cell may further include a gasket that is integrally formed with, or a separate component from, the cassette such that an open well is formed between the substrate and the gasket into which one or more samples may be positioned. In particular, the present disclosure describes a stackable lid that is attachable to the open well flow cell to thereby seal the open well flow cell (e.g., to prevent evaporation of reagents within the open well during thermocycling or incubation). For purpose of explanation and illustration, and not limitation, an exemplary embodiment of the assembly in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

As described in U.S. Pat. App. Pub. No. 2024-0033744, the entire contents of which are hereby incorporated by reference, target molecules (e.g., nucleic acids, proteins, antibodies, etc.) can be detected in biological samples (e.g., one or more cells or a tissue sample) using an instrument having integrated optics and fluidics modules (an “opto-fluidic instrument” or “opto-fluidic system”). In an opto-fluidic instrument, the fluidics module is configured to deliver one or more reagents (e.g., fluorescent probes) to the biological sample and/or remove spent reagents therefrom. Additionally, the optics module is configured to illuminate the biological sample with light having one or more spectral emission curves (over a range of wavelengths) and subsequently capture one or more images of emitted light signals from the biological sample during one or more probing cycles. In various embodiments, the captured images may be processed in real time and/or at a later time to determine the presence of the one or more target molecules in the biological sample, as well as three-dimensional position information associated with each detected target molecule. Additionally, the opto-fluidics instrument includes a sample module configured to receive (and, optionally, secure) one or more biological samples. In some instances, the sample module includes an X-Y stage configured to move the biological sample along an X-Y plane (e.g., perpendicular to an objective lens of the optics module).

In various embodiments, the opto-fluidic instrument is configured to analyze one or more target molecules in their naturally occurring place (i.e., in situ) within the biological sample. For example, an opto-fluidic instrument may be an in situ analysis system used to analyze a biological sample and detect target molecules including but not limited to DNA, RNA, proteins, antibodies, and/or the like.

A sample disclosed herein can be or be derived from any biological sample. Biological samples may be obtained from any suitable source using any of a variety of techniques including, but not limited to, biopsy, surgery, and laser capture microscopy (LCM), and generally includes cells, tissues, and/or other biological material from the subject. A biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample from a mammal. A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic subjects, subjects that have or are suspected of having a disease (e.g., an individual with a disease such as cancer) or a pre-disposition to a disease, and/or subjects in need of therapy or suspected of needing therapy.

The biological sample can include any number of macromolecules, for example, cellular macromolecules and organelles (e.g., mitochondria and nuclei). The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions.

In some embodiments, the biological sample may comprise cells or a tissue sample which are deposited on a substrate. As described herein, a substrate can be any support that is insoluble in aqueous liquid and allows for positioning of biological samples, analytes, features, and/or reagents on the support. In some embodiments, a biological sample is attached to a substrate. In some embodiments, the substrate is optically transparent to facilitate analysis on the opto-fluidic instruments disclosed herein. For example, in some instances, the substrate is a glass substrate (e.g., a microscopy slide, cover slip, or other glass substrate). Attachment of the biological sample can be irreversible or reversible, depending upon the nature of the sample and subsequent steps in the analytical method. In certain embodiments, the sample can be attached to the substrate reversibly by applying a suitable polymer coating to the substrate and contacting the sample to the polymer coating. The sample can then be detached from the substrate, e.g., using an organic solvent that at least partially dissolves the polymer coating. Hydrogels are examples of polymers that are suitable for this purpose. In some embodiments, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

A variety of steps can be performed to prepare or process a biological sample for and/or during an assay using the opto-fluidic instruments disclosed herein. Except where indicated otherwise, the preparative or processing steps described below can generally be combined in any manner and in any order to appropriately prepare or process a particular sample for and/or analysis.

For example, a biological sample can be harvested from a subject (e.g., via surgical biopsy, whole subject sectioning) or grown in vitro on a growth substrate or culture dish as a population of cells and prepared for analysis as a tissue slice or tissue section (e.g., a fresh frozen, fixed frozen, or formalin fixed paraffin embedded (FFPE) tissue section). The thickness of a tissue section typically depends on the method used to prepare the section and the physical characteristics of the tissue, and therefore sections having a wide variety of different thicknesses can be prepared and used.

In some instances, the biological sample is fixed in any of a variety of suitable fixatives to preserve the biological structure of the sample prior to analysis. Exemplary fixatives include formalin, formaldehyde, ethanol, methanol, acetone, paraformaldehyde (PFA)-Triton, and combinations thereof.

In some embodiments, a biological sample can be permeabilized to facilitate transfer of analytes out of the sample, and/or to facilitate transfer of species (such as probes or probes sets) into the sample. In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X-100™ or Tween-20™), and enzymes (e.g., trypsin, proteases).

In some embodiments, the biological sample is embedded in a polymer and/or crosslinked matrix (e.g., a hydrogel matrix). Embedding the sample in this manner typically involves contacting the biological sample with a hydrogel such that the biological sample becomes surrounded by the hydrogel. For example, the sample (e.g., a tissue section on a substrate, such as a glass substrate) can be embedded by contacting the sample with a suitable polymer material and activating the polymer material to form a hydrogel. In some embodiments, the hydrogel is formed such that the hydrogel is internalized within the biological sample. In some embodiments, the biological sample (including biological analytes) is immobilized in the hydrogel via cross-linking of the polymer material that forms the hydrogel. Cross-linking can be performed chemically and/or photochemically, or alternatively by any other suitable hydrogel-formation method. In some instances, biological molecules (or derivatives thereof) are cross-linked or otherwise covalently attached to the hydrogel. For example, in some embodiments, nucleic acid molecules (or derivatives thereof, such as an amplification product or probe(s) bound to cellular nucleic acid molecule) in a tissue sample are cross-linked or otherwise covalently attached to the hydrogel.

Hydrogels embedded within biological samples can be cleared using any suitable method. For example, electrophoretic tissue clearing methods or surfactant-based (e.g., sodium dodecyl sulfate (SDS)) clearing methods can be used to remove biological macromolecules from the hydrogel-embedded sample.

Tissue clearing is a process of optically resolving a sample or complex biological material, such as whole organs, large tissue, and cellular models, with minimal changes to morphology and without compromising the ability for immunolabeling or fluorescence imaging detection. In various embodiments, refractive index matching is used for obtaining fluorescence images. Mismatching among mediums can cause loss of imaging resolution, as light may need to travel through the sample itself, a mounting media, glass coverslip, oil, and/or a microscope objective. In various embodiments, the amount of variable scattering of light from cellular membranes, lipids, and/or molecules of the specimen is reduced (e.g., minimized) using the various methods described herein. Heterogeneity of scattering among the cellular components may lead to an increase in opaqueness of an image. In various embodiments, a denser makeup of lipids, trafficking organelles, and other subcellular molecules may increase lateral, or non-forward, light scattered. In various embodiments, non-forward light scattering in situ may not pass through the specimen, as it is exacerbated by the continuous, pinball like, interactions of scattered light with neighboring molecules. In various embodiments, through the multiplicity of scattering, refraction, and absorbance the energy of light may be reduced or ultimately lost, leading to a distorted and white, non-translucent image. In various embodiments, a clearing reagent and mountant optically clears the sample by matching the refractive index to minimizing the light scattering through the specimen and to the microscope objective.

In various embodiments, optical clearing may be performed via various different approaches, primarily being divided into chemical and matrix-based approaches. In various embodiments, chemical approaches include aqueous-based or solvent-based approaches to achieve a highly resolved 3D image for immunolabeling, immuno-cytochemistry, immuno-histochemistry, and/or immunofluorescence. In various embodiments, aqueous-based clearing approaches are generally used to avoid dehydration and toxicity, which can destroy the integrity of a sample.

In various embodiments, passive clarity technique (PACT) is a passive tissue clearing and immunolabeling protocol. In various embodiments, PACT is used for intact thick organs. In various embodiments, RIMS includes a protocol for passive tissue clearing and immunostaining of intact organs that is compatible for long-term storage and has imaging media that preserves fluorescent markers over months.

In various embodiments, refractive index matching solutions (RIMS) may be produced with sugar or glycerol for simple, passive immersion. This may be preferred with thinner or smaller samples, because they are easier to clear and can maintain fluorescent protein emission. In various embodiments, such immersion techniques may achieve less than 1.5 refractive index and can take days to achieve clearing, resulting in reduced image quality when compared to solvent approaches, due to refractive index mismatching between the cleared sample, the glass coverslip, and immersion oil (glass and oil have an RI of 1.51). As sugar or glycerol solutions may take extended periods for clearing, a sample can experience considerable shrinkage while losing lipid content. In various embodiments, commercially available solutions control morphological alterations and loss of lipid content while achieving a higher refractive index of 1.52. In various embodiments, considerations for clearing include sample type and thickness so that there is minimal shrinkage of the sample and preservation of lipid content and fluorescence.

In various embodiments, perfusion-assisted agent release in situ (PARS) includes a method for whole-body clearing and phenotyping compatible with endogenous fluorescence. In various embodiments, all steps for PARS, including preservation, clearing, and labeling, are performed in situ prior to tissue extraction. In various embodiments, PARS, together with RIMS, transform opaque, intact, whole-organisms into optically transparent, fluorescently labeled samples for visualization with conventional confocal microscopy and phenotypic analysis at the cellular, subcellular, and/or single-molecule transcripts level as described in Single-Cell Phenotyping within Transparent Intact Tissue through Whole-Body Clearing by Yang et al. Cell. Vol 158, Issue 4, P945-958, Aug. 14, 2014 (accessible online at https://doi.org/10.1016/j.cell.2014.07.017).

A biological sample may comprise one or a plurality of analytes of interest. The opto-fluidic instruments disclosed herein can be used to detect and analyze a wide variety of different analytes. In some aspects, an analyte can include any biological substance, structure, moiety, or component to be analyzed. For example, the analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed and detected (e.g., using the opto-fluidic instruments disclosed herein).

Analytes of particular interest may include nucleic acid molecules, such as DNA (e.g. genomic DNA, mitochondrial DNA, plastid DNA, viral DNA, etc.) and RNA (e.g. mRNA, microRNA, rRNA, snRNA, viral RNA, etc.), and synthetic and/or modified nucleic acid molecules, (e.g. including nucleic acid domains comprising or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof. The analyte may be a single molecule or a complex that contains two or more molecular subunits, e.g., including but not limited to complexes between proteins or peptides and nucleic acid molecules such as DNA or RNA, e.g., interactions between proteins and nucleic acids, e.g., regulatory factors, such as transcription factors, and DNA or RNA.

In some embodiments, the opto-fluidic instruments described herein can be utilized for the in situ detection and analysis of cellular analytes, (such as nucleic acid sequences), such as fluorescent in situ hybridization (FISH)-based methods, in situ transcriptomic analysis, or in situ sequencing, for example from intact tissues or samples in which the spatial information has been preserved. In some aspects, the embodiments can be applied in an imaging or detection method for multiplexed nucleic acid analysis. In some aspects, the provided opto-fluidic instruments can be used to detect a signal associated with a detectable label of a nucleic acid probe that is hybridized to a target sequence of a target nucleic acid in a biological sample.

Disclosed herein, in some aspects, are labelling agents (e.g., nucleic acid probes and/or probe sets) that are introduced into a cell or used to otherwise detect an analyte in a biological sample such as a tissue sample. The labelling agents include nucleic acid-based probes (e.g., the primary probes disclosed herein and/or any detectable probe disclosed herein) and may comprise any of a variety of entities that can hybridize to a nucleic acid, typically by Watson-Crick base pairing, such as DNA, RNA, LNA, PNA, etc. The nucleic acid probes may comprise a hybridization region that is able to directly or indirectly bind to at least a portion of a target sequence in a target nucleic acid. The nucleic acid probe may be able to bind to a specific target nucleic acid (e.g., an mRNA, or other nucleic acids disclosed herein).

Specific probe designs can vary depending on the application and any suitable probe or probe set may be utilized and detected using the opto-fluidic instruments described herein. In some aspects, the probes or probe sets described herein, or intermediate probes (e.g., a secondary probe, and/or a higher order probe) can be selected from the group consisting of a circular probe, a circularizable probe, and a linear probe. In some embodiments, a circular probe is pre-circularized prior to hybridization to a target nucleic acid and/or one or more other probes. In some embodiments, a circularizable probe is circularized (e.g., by ligation) upon hybridization to a target nucleic acid and/or one or more other probes such as a splint. In some embodiments, a linear probe can be one that comprises a target recognition sequence and a sequence that does not hybridize to a target nucleic acid, such as a 5′ overhang, a 3′ overhang, and/or a linker or spacer (which may comprise a nucleic acid sequence, such a one or more barcode sequence, or a non-nucleic acid moiety). In some embodiments, the sequence (e.g., the 5′ overhang, 3′ overhang, and/or linker or spacer) is non-hybridizing to the target nucleic acid but may hybridize to one another and/or one or more other probes, such as detectably labeled probes.

In some embodiments, a primary probe, a secondary probe, and/or a higher order probe disclosed herein can comprise a padlock-like probe or probe set, such as one described in U.S. Pat. No. 8,551,710, US 2020/0224244, US 2019/0055594, US 2021/0164039, US 2016/0108458, or US 2020/0224243, each of which is incorporated herein by reference in its entirety. Any suitable combination of the probe designs described herein can be used.

In some embodiments, the probes or probe sets described herein (e.g., a primary probe,) or a secondary probe, and/or a higher order probe disclosed herein can comprise two or more parts. In some cases, a probe can comprise one or more features of and/or be modified based on: a split FISH probe or probe set described in WO 2021/167526A1 or Goh et al., “Highly specific multiplexed RNA imaging in tissues with split-FISH,” Nat Methods 17(7):689-693 (2020), which are incorporated herein by reference in their entireties; a Z-probe or probe set, such as one described in U.S. Pat. Nos. 7,709,198 B2, 8,604,182 B2, 8,951,726 B2, 8,658,361 B2, or Tripathi et al., “Z Probe, An Efficient Tool for Characterizing Long Non-Coding RNA in FFPE Tissues,” Noncoding RNA 4(3):20 (2018), which are incorporated herein by reference in their entireties; an HCR initiator or amplifier, such as one described in U.S. Pat. No. 7,632,641 B2, US 2017/0009278 A1, U.S. Pat. No. 10,450,599 B2, or Choi et al., “Third-generation in situ hybridization chain reaction: multiplexed, quantitative, sensitive, versatile, robust,” Development 145(12):dev165753 (2018), which are incorporated herein by reference in their entireties; a PLAYR probe or probe set, such as one described in US 2016/0108458 A1 or Frei et al., “Highly multiplexed simultaneous detection of RNAs and proteins in single cells,” Nat Methods 13(3):269-75 (2016), which are incorporated herein by reference in their entireties; a PLISH probe or probe set, such as one described in US 2020/0224243 A1 or Nagendran et al., “Automated cell-type classification in intact tissues by single-cell molecular profiling,” eLife 7:e30510 (2018), which are incorporated herein by reference in their entireties; a RollFISH probe or probe set such as one described in Wu et al., “RollFISH achieves robust quantification of single-molecule RNA biomarkers in paraffin-embedded tumor tissue samples,” Commun Biol 1, 209 (2018), which is hereby incorporated by reference in its entirety; a MERFISH probe or probe set, such as one described in US 2022/0064697 A1 or Chen et al., “Spatially resolved, highly multiplexed RNA profiling in single cells,” Science 348(6233):aaa6090 (2015), which are incorporated herein by reference in their entireties; a primer exchange reaction (PER) probe or probe set, such as one described in US 2019/0106733 A1, which is hereby incorporated by reference in its entirety.

In some instances, probes and/or probe sets are directly labeled with one or more detectable labels (e.g., an optically detectable label, such as a florescent moiety) that are detected on the opto-fluidic instruments disclosed herein. In other instances, probes and/or probe sets comprise a target binding region and one or more nucleic acid barcode sequences that identify the analyte. In these embodiments, the barcode sequence(s) may be detected on the opto-fluidic instruments disclosed herein to identify the analyte in the sample. In some instances, a probe or probe set disclosed herein is a circularizable probe or probe set (e.g., a padlock probe or padlock-like probe) comprising a barcode region comprising one or more barcode sequences.

The probes and/or probe sets describe herein may comprise any suitable number of barcode sequences. In some embodiments, the probes or probe sets may comprise 1, 2, 3, 4, 5, 6, 7, 8, 9, 10, 11, 12, 13, 14, 15 or more, 20 or more, 32 or more, 40 or more, or 50 or more barcode sequences. As an illustrative example, a first probe may contain a first target-binding sequence, a first barcode sequence, and a second barcode sequence, while a second, different probe may contain a second target-binding sequence (that is different from the first target-binding sequence in the first probe), the same first barcode sequence as in the first probe, but a third barcode sequence instead of the second barcode sequence. Such probes may thereby be distinguished by determining the various barcode sequence combinations present or associated with a given probe at a given location in a sample.

In some embodiments, a labelling agent may include analyte binding moiety that interacts with an analyte (e.g., a protein) in the sample (e.g., a cell or tissue sample) and a reporter oligonucleotide comprising one or more barcode sequences associated with the analyte and/or analyte binding moiety. For example, a labelling agent that is specific to one type of cell feature (e.g., a first protein) may have coupled thereto a first reporter oligonucleotide, while a labelling agent that is specific to a different cell feature (e.g., a second protein) may have a different reporter oligonucleotide coupled thereto. In some embodiments, an analyte binding moiety includes, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some embodiments, the nucleic acid probes, probe sets, reporter oligonucleotides, barcode sequences, etc. may be detected directly on the opto-fluidic instruments disclosed herein (e.g., primary probes comprise a detectable label, such as a florescent moiety), and/or by using secondary (or higher order) nucleic acid probes able to bind to the primary probes. In some embodiments, the nucleic acid probes (e.g., primary probes and/or secondary probes) are compatible with one or more biological and/or chemical reactions. For instance, a nucleic acid probe disclosed herein can serve as a template or primer for a polymerase (e.g., a circularized probe in a rolling circle amplification (RCA) reaction), a template or substrate for a ligase, a substrate for a click chemistry reaction, and/or a substrate for a nuclease (e.g., endonuclease or exonuclease for cleavage or digestion). In some instances, labelling agents (such as a primary probe set) are added to a biological sample (e.g., a cell or tissue sample) using the opto-fluidic instrument and subsequently detected using opto-fluidic instrument (e.g., using detectably labeled primary probes, sequential hybridization of detectable labelled oligonucleotides to primary probes, in situ sequencing (e.g., SBS, SBL, SBH), and the like). In some instances, labelling agents (such as a primary probe set) are added to a biological sample (e.g., a cell or tissue sample) outside the optofluidic instrument and the sample is loaded onto the opto-fluidic instruments disclosed herein for detection (e.g., using sequential hybridization of detectable labelled oligonucleotides, in situ sequencing (e.g., SBS, SBL, SBH), and the like).

In some embodiments, detection of the analytes, probes, probe sets, barcodes, etc. described herein can be performed in situ on the opto-fluidic instruments disclosed herein. In situ sequencing typically involves incorporation of a labeled nucleotide (e.g., fluorescently labeled mononucleotides or dinucleotides) in a sequential, template-dependent manner or hybridization of a labeled primer (e.g., a labeled random hexamer) to a nucleic acid template such that the identities (e.g., nucleotide sequence) of the incorporated nucleotides or labeled primer extension products can be determined, and consequently, the nucleotide sequence of the corresponding template nucleic acid. Aspects of in situ sequencing approaches are described, for example, in Mitra et al., (2003) Anal. Biochem. 320, 55-65, and Lee et al., (2014) Science, 343 (6177), 1360-1363. In addition, examples of methods and systems for performing in situ sequencing are described in US 2016/0024555, US 2019/0194709, and in U.S. Pat. Nos. 10,138,509, 10,494,662 and 10,179,932.

In some embodiments, sequencing can be performed by sequencing-by-synthesis (SBS). In some embodiments, a sequencing primer is complementary to sequences at or near the target to be detected (e.g., one or more barcode(s)). In such embodiments, sequencing-by-synthesis can comprise reverse transcription and/or amplification in order to generate a template sequence from which a primer sequence can bind. Exemplary SBS methods comprise those described for example, but not limited to, US 2007/0166705, US 2006/0188901, U.S. Pat. No. 7,057,026, US 2006/0240439, US 2006/0281109, US 2011/005986, US 2005/0100900, U.S. Pat. No. 9,217,178, US 2009/0118128, US 2012/0270305, US 2013/0260372, and US 2013/0079232.

In some embodiments, sequence analysis of nucleic acids (e.g., nucleic acids such as RCA products comprising barcode sequences) can be performed by sequential hybridization (e.g., sequencing by hybridization and/or sequential in situ fluorescence hybridization). Sequential fluorescence hybridization can involve sequential hybridization of detection probes comprising an oligonucleotide and a detectable label. In some embodiments, a method disclosed herein comprises sequential hybridization of the detectable probes disclosed herein, including detectably labeled probes (e.g., fluorophore conjugated oligonucleotides) and/or probes that are not detectably labeled per se but are capable of binding (e.g., via nucleic acid hybridization) and being detected by detectably labeled probes. Exemplary methods comprising sequential fluorescence hybridization of detectable probes are described in US 2019/0161796, US 2020/0224244, US 2022/0010358, US 2021/0340618, and WO 2021/138676, MERFISH (described for example in Moffitt, (2016) Methods in Enzymology, 572, 1-49), and hybridization-based in situ sequencing (HybISS) (described for example in Gyllborg et al., Nucleic Acids Res (2020) 48(19):e112) all of which are incorporated herein by reference.

In some embodiments, sequencing can be performed using sequencing by ligation (SBL). Such techniques utilize DNA ligase to incorporate oligonucleotides and identify the incorporation of such oligonucleotides. The oligonucleotides typically have different labels that are correlated with the identity of a particular nucleotide in a sequence to which the oligonucleotides hybridize. Aspects and features involved in sequencing by ligation are described, for example, in Shendure et al. Science (2005), 309:1728-1732, and in U.S. Pat. Nos. 5,599,675; 5,750,341; 6,969,488; 6,172,218; US and 6,306,597. Exemplary techniques for in situ SBL comprise, but are not limited to, STARmap (described for example in Wang et al., (2018) Science, 361 (6499) 5691) and US 2021/0164039).

In some embodiments, probe barcodes (e.g., plurality of probes or probe sets comprising one or more barcode sequences) or complements or products thereof are targeted by detectably labeled detection oligonucleotides, such as fluorescently labeled oligonucleotides. In some embodiments, one or more decoding schemes (e.g., sequential rounds of fluorescent probe hybridization) are used on the opto-fluidic instruments disclosed herein to decode the signals, such as fluorescence, for sequence identification. In any of the embodiments herein, barcodes (e.g., primary and/or secondary barcode sequences) can be analyzed (e.g., detected or sequenced using the opto-fluidic instruments disclosed herein) using any suitable methods or techniques, comprising those described herein, such as RNA sequential probing of targets (RNA SPOTs), sequential fluorescent in situ hybridization (seqFISH), single-molecule fluorescent in situ hybridization (smFISH), multiplexed error-robust fluorescence in situ hybridization (MERFISH), hybridization-based in situ sequencing (HybISS), in situ sequencing, targeted in situ sequencing, fluorescent in situ sequencing (FISSEQ), or spatially-resolved transcript amplicon readout mapping (STARmap). In some embodiments, the methods provided herein comprise analyzing the barcodes by sequential hybridization and detection with a plurality of labelled probes (e.g., detection oligonucleotides or detectable probes). Exemplary decoding schemes are described in Eng et al., “Transcriptome-scale Super-Resolved Imaging in Tissues by RNA SeqFISH+,” Nature 568(7751):235-239 (2019); Chen et al., Science; 348(6233):aaa6090 (2015); Gyllborg et al., Nucleic Acids Res (2020) 48(19):e112; U.S. Pat. No. 10,457,980 B2; US 2016/0369329 A1; WO 2018/026873 A1; and US 2017/0220733 A1, all of which are incorporated by reference in their entirety. In some embodiments, these assays enable signal amplification, combinatorial decoding, and error correction schemes at the same time.

It is to be noted that, although the above discussion relates to an opto-fluidic instrument that can be used for in situ target molecule detection via probe hybridization, the discussion herein equally applies to any opto-fluidic instrument that employs any imaging or target molecule detection technique. That is, for example, an opto-fluidic instrument may include a fluidics module that includes fluids needed for establishing the experimental conditions required for the probing of target molecules in the sample. Further, such an opto-fluidic instrument may also include a sample module configured to receive the sample, and an optics module including an imaging system for illuminating (e.g., exciting one or more fluorescent probes within the sample) and/or imaging light signals received from the probed sample. The opto-fluidic instrument may also include other ancillary modules configured to facilitate the operation of the opto-fluidic instrument, such as, but not limited to, cooling systems, motion calibration systems, etc.

In some embodiments, the afore-mentioned sample preparation or processing steps are performed in a sealed well or chamber of the open well flow cell. For example, the sample preparation or processing steps may include incubation of the sample (e.g., in the presence of a reagent) in a sample device, and the incubation may be performed in a sealed chamber to reduce or eliminate evaporative loss. Heat for the incubation may be provided by heat sources that are thermally coupled to the sample device. For example, a sealed sample device containing a sample may be placed in a thermal cycler to amplify analytes (e.g., DNA, RNA, etc.) in the sample that are to be detected. In such cases, a heated lid of the thermal cycler may be in direct contact with, or otherwise thermally coupled to, a side of the sample device (e.g., a lid), delivering heat to the sample for incubating the same. Other sources of heat for incubating the sample may include but are not limited to thermoelectric coolers (TECs). For example, the hot-side of a TEC that may be in direct contact with, or otherwise thermally coupled to, a side of the sample device to provide heat for sample incubation.

As used herein the specification, “a” or “an” may mean one or more. As used herein in the claim(s), when used in conjunction with the word “comprising,” the words “a” or “an” may mean one or more than one. Some embodiments of the disclosure may consist of or consist essentially of one or more elements, method steps, and/or methods of the disclosure. It is contemplated that any method or composition described herein can be implemented with respect to any other method or composition described herein and that different embodiments may be combined.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

The use of the term “or” in the claims is used to mean “and/or” unless explicitly indicated to refer to alternatives only or the alternatives are mutually exclusive, although the disclosure supports a definition that refers to only alternatives and “and/or.” For example, “x, y, and/or z” can refer to “x” alone, “y” alone, “z” alone, “x, y, and z,” “(x and y) or z,” “x or (y and z),” or “x or y or z.” It is specifically contemplated that x, y, or z may be specifically excluded from an embodiment. As used herein “another” may mean at least a second or more.

The term “ones” means more than one. As used herein, the term “plurality” can be 2, 3, 4, 5, 6, 7, 8, 9, 10, or more. As used herein, the term “set of” means one or more. For example, a set of items includes one or more items.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

As used herein, the term “about” refers to include the usual error range for the respective value readily known. Reference to “about” a value or parameter herein includes (and describes) embodiments that are directed to that value or parameter per se. For example, description referring to “about X” includes description of “X”. In some embodiments, “about” may refer to ±15%, ±10%, ±5%, or ±1% as understood by a person of skill in the art.

As used herein, in some instances, the term “thermal coupling”, or variants thereof, refer to configurations of two or more components that allow heat to be exchanged with each other directly (e.g., in direct contact) or indirectly such that the temperature of one or both of them increases or decreases.

While the present teachings are described in conjunction with various embodiments, it is not intended that the present teachings be limited to such various embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

As shown in FIGS. 1A-1B, an assembly 100 is shown in perspective and front views. In various embodiments, the assembly 100 includes a sample device (e.g., a cassette) 104 securing a substrate (e.g., glass slide) on which one or more samples may be positioned. The assembly further includes a gasket, where the cassette, substrate, and gasket form an open well flow cell. In the present disclosure, the words “cassette,” “sample device,” and “sample holder” are used interchangeably for reference 104. In various embodiments, the assembly 100 includes a lid 120 configured to cover and seal the open well flow cell. In various embodiments, the sample device 104 includes a top portion 108 and a bottom portion 112. In various embodiments, the top portion 108 is formed from injected molded plastic having a generally rectilinear or rectangular shape (in some embodiments with rounded or chamfered corners) and a plurality of apertures formed therein. In various embodiments, the top portion 108 includes a plurality of apertures configured to matingly engage a plurality of snap joint elements from the bottom portion 112 as will be described below.

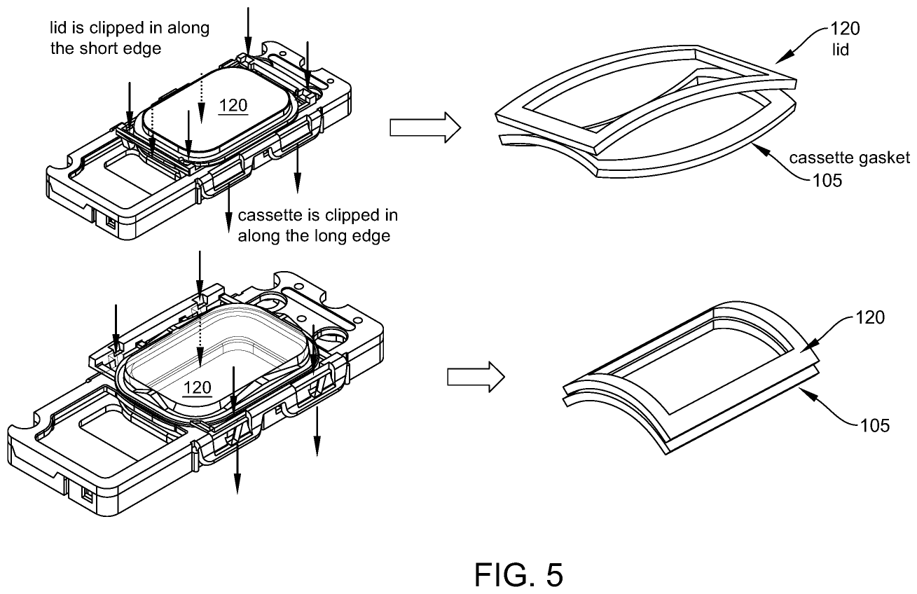

In various embodiments, the plurality of apertures are registration locations of insertion of the sample device 104 into a larger assembly or machine, such as an incubation or imaging instruments. In various embodiments, the plurality of apertures is configured to receive the plurality of snap joint elements to extend therethrough. In various embodiments, the lid 120 is attached to the sample device 104 via clips which can engage the bottom portion 112 of the cassette (sandwiching the top portion 108 therebetween) to thereby mitigate evaporative loss during incubation and/or other sample preparation steps. In various embodiments, a plastic clip-on lid reduces at least some evaporative loss. Moreover, clipping a lid along the short edge of the cassette may lead to reduced performance due to the design of the sample device 104 itself (as shown in the top embodiment of FIG. 5). That is, due to the forces exerted (e.g. pressure during closing the lid, incubation, etc.) gaps or regions of uneven clamping force can form between the lid 120 and the underlying gasket, and top portion 108 of the cassette, causing undesired evaporation/waste of the reagents and potentially compromising the sample preparation process (which may also affect the downstream analysis of analytes).

In accordance with an aspect of the present disclosure, the coupling features of the lid disclosed herein are effectively rotated 90° to provide forces that cause deformation (e.g., bowing) in the lid 120 that matches the deformation (e.g., bowing) of the underlying sample device 104 and/or gasket. In various embodiments, the longer side of the sample device 104 provides more space for the coupling features to engage with bottom 112 of the cassette (as shown in the bottom embodiment of FIG. 5), as opposed to the top 108 (as shown in the top embodiment of FIG. 5), which can increase the efficacy of the lid 120 in sealing against the sample device 104. Thus, with the lid design disclosed herein, the lid 120 can deform in the same shape, and contour, as the underlying gasket-so that the seal of the reagents in the well is effectively maintained and evaporation is reduced or prevented. Although the exemplary embodiment illustrated depicts two coupling features on each (long) side of the cassette (in the bottom embodiment of FIG. 5) additional, or less, coupling features can be employed to achieve the desired clamping force between the lid 120 and the bottom 112 of the cassette.

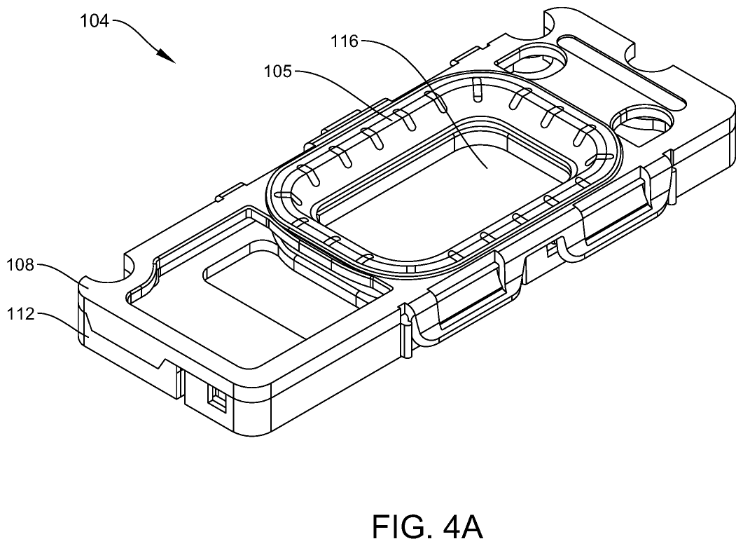

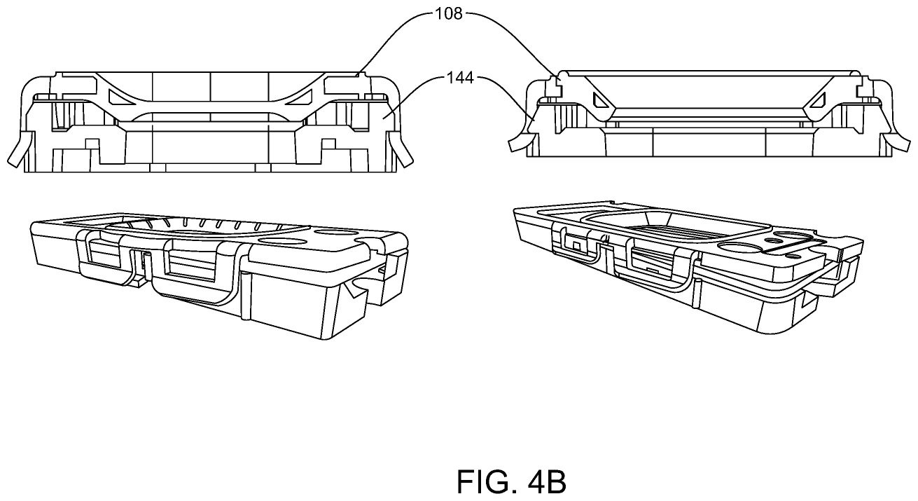

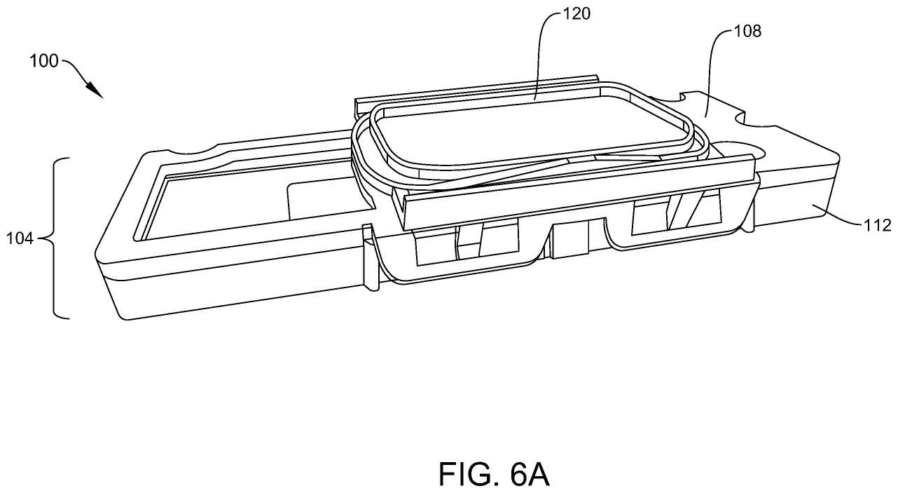

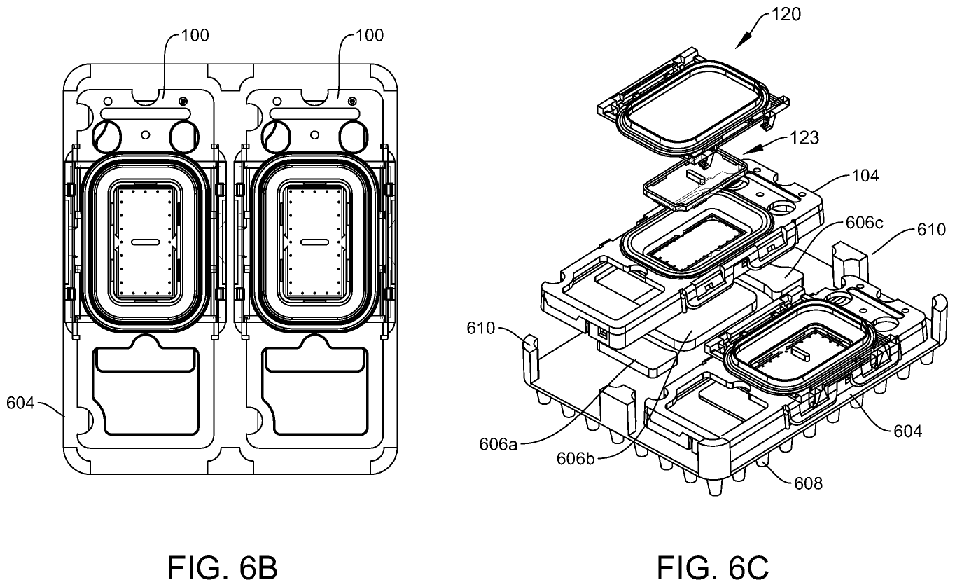

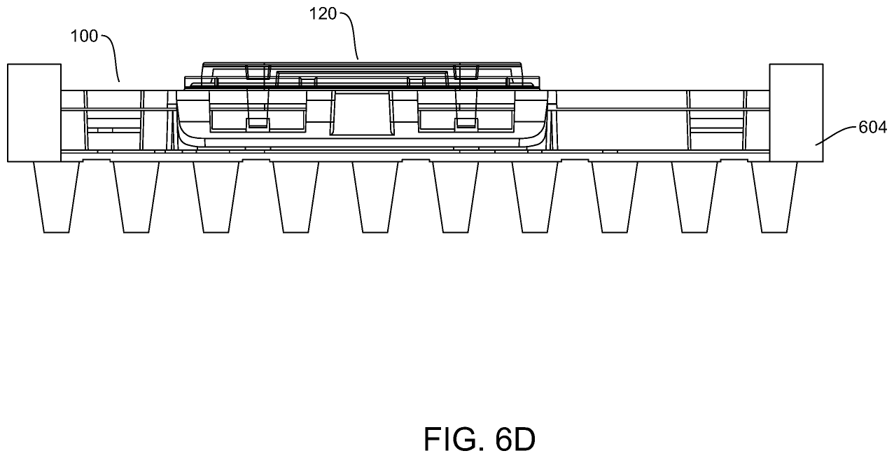

In various embodiments, the top portion 108 includes an opening 116 formed therein. In various embodiments, the opening 116 is circumscribed by a gasket 105 such that an open well 117 is defined by the opening 116, the sample substrate (e.g., glass slide), and the gasket 105 (see FIG. 4A). In various embodiments, the gasket 105 is disposed about the periphery of the opening 116, and the gasket 105 includes an angled inner surface, such that the gasket 105 forms a sloped cross-sectional inner surface. In various embodiments, the open well 117 is approximately 3.5 mm deep, although other dimensioned wells are within the scope of this disclosure. In various embodiments, the open well 117 is about 1 mm to about 10 mm deep. In various embodiments, the open well 117 is about 1 mm to about 5 mm deep. In various embodiments, the open well 117 is about 2 mm to about 4 mm deep. In various embodiments, the open well 117 is about 3 mm to about 4 mm deep. In various embodiments, the open well 117 is configured to receive an insert 123 (see FIG. 6C). In various embodiments, the insert 123 is configured to be positioned within the open well 117 and contacting the sample substrate, such as a glass slide having a biological sample disposed thereon. In various embodiments, the insert 123 is configured to reduce the volume of reagent required to fully cover the imaging area of the sample substrate. Exemplary inserts are described in U.S. patent application Ser. No. 19/060,122, filed on Feb. 21, 2025, which is incorporated by reference herein in its entirety. As will be described below, when a lid 120 engages the sample device 104, the gasket 105 couples with the periphery of a flange 128 on the lid 120 to form a seal. In various embodiments, when the lid 120 engages the sample device 104, the total inner height between the bottom of the well 117 to the bottom surface of the lid 120 is approximately 5.5 mm (about 2 mm higher than the depth of the open well 117), although other dimensioned wells are within the scope of this disclosure. In various embodiments, the total height of the assembly 100 (e.g., “h” in FIG. 1B), measured from the bottom of the bottom surface 112 to the top planar surface of the lid 120 is approximately 9 mm. In various embodiments, the total height of the assembly 100 (e.g., “h” in FIG. 1B), measured from the bottom of the bottom surface 112 to the top planar surface of the lid 120 is approximately 9.9 mm. In various embodiments, the total height of the assembly 100 (e.g., “h” in FIG. 1B), measured from the bottom of the bottom surface 112 to the top planar surface of the lid 120 is approximately 10 mm. In various embodiments, the total height of the assembly 100 is about 5 mm to about 15 mm. In various embodiments, the total height of the assembly 100 is about 7.5 mm to about 10 mm. In some embodiments, the lid 120 is about 0.75 mm to about 1.00 mm thick, the cassette well is about 3.5 mm deep, and the bottom surface of the lid extends approximately 2 mm above the planar top surface of the open well 117, so the total height from the glass slide to the bottom side of the lid dome is approximately 5.5 mm.

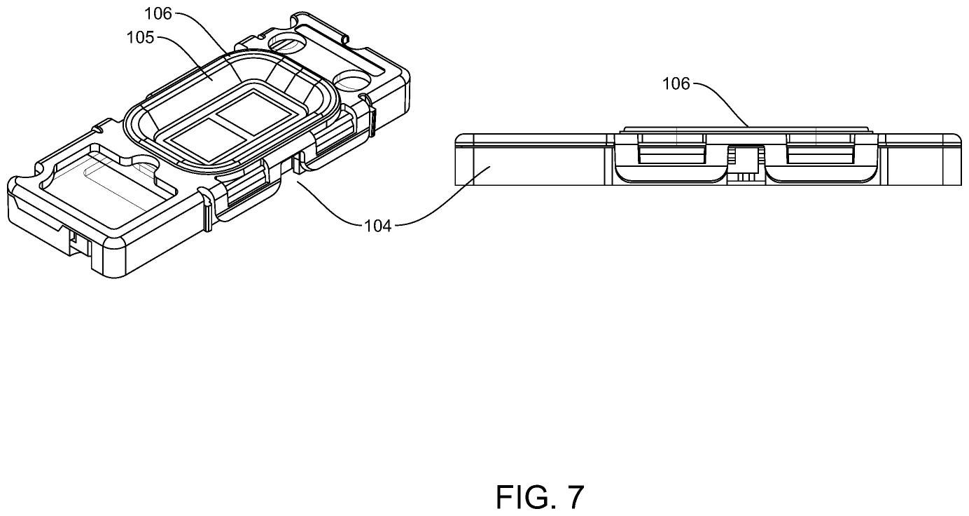

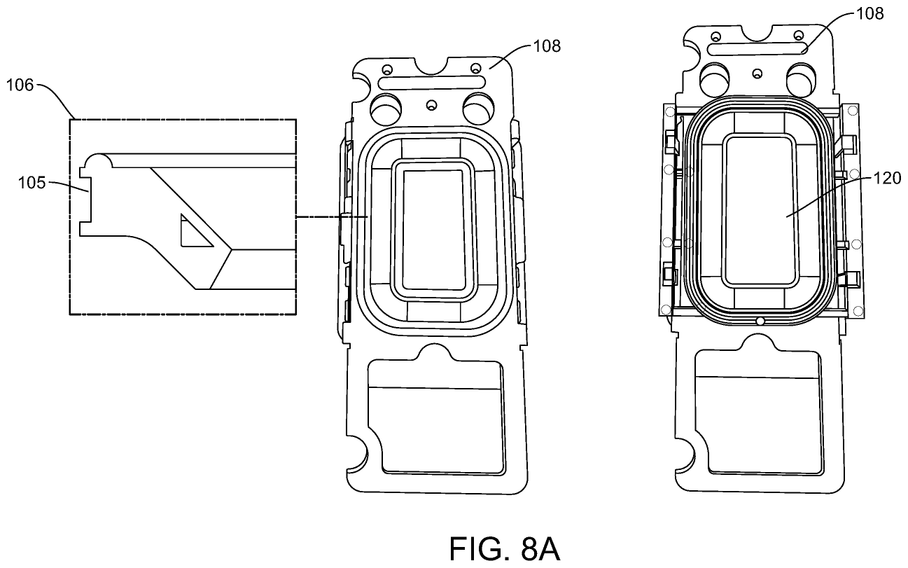

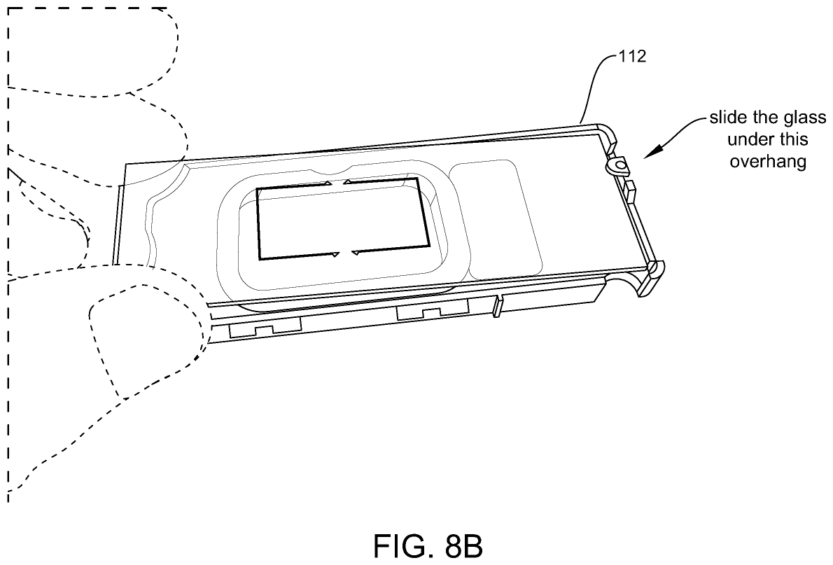

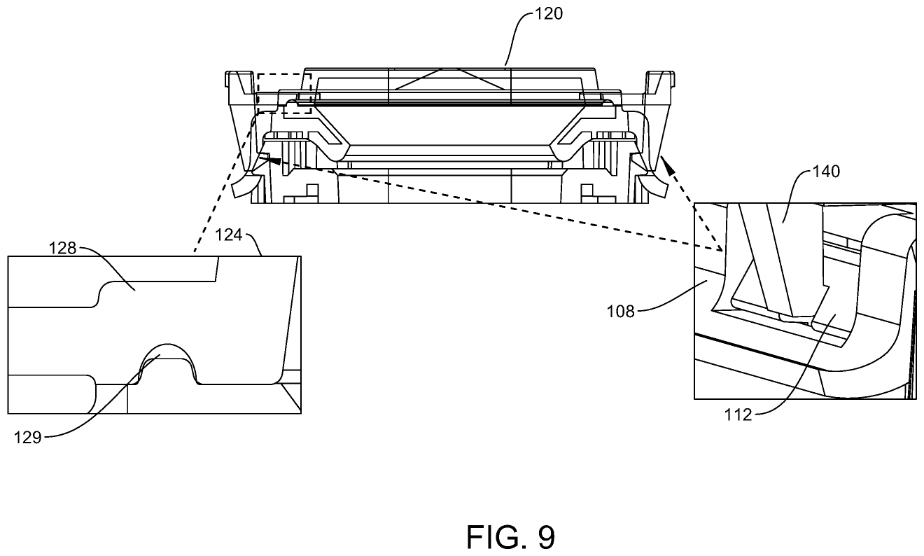

In various embodiments, the gasket 105 includes an O-ring element 106 (see FIG. 7). In various embodiments, the O-ring element 106 is disposed at a topmost portion of gasket 105 and circumscribe said topmost element, and protrudes above the top portion 108. In various embodiments, the O-ring element 106 is configured to mate with a groove formed in the flange 128 of the lid 120 to thereby form a seal between the lid 120 and the gasket 105. In various embodiments, the O-ring element 106 extends from the topmost portion of the gasket 105. In various embodiments, the O-ring element 106 has a rounded profile, such as a semicircular profile as shown in FIG. 7 and FIG. 8A. For example and without limitation, the O-ring element 106 may be a unitary component with the gasket 105 or coupled thereto. In various embodiments, the O-ring element 106 may include a 0.94 mm radius, and offset from the angled surface of the gasket 105 by about 0.65 mm. In various embodiments, the O-ring element 106 may include a planform shape similar to the planform shape of gasket 105, such as a rectangular shape with round corners.

In various embodiments, the cassette 104 includes a bottom portion 112 that is generally rectilinear, with opposite pairs of sides, wherein a first pair of sides is longer than the second pair of sides. In various embodiments, the bottom portion 112 is configured to releasably couple to top portion 108. In various embodiments, the top portion 108 and the bottom portion 112 are configured to snap together via snap joint elements, or a plurality of bosses and slots, tongue/groove, spring biased “fingers”, or other mechanical fastening elements. In various embodiments, a gap is formed between the bottom portion 112 and the top portion 108 when the bottom portion is coupled to the top portion. In various embodiments, the gap is configured to receive a substrate (e.g., a glass slide with or without a sample disposed thereon) therein, when the bottom portion is coupled to the top portion and the gap is formed. As shown in FIG. 4A, the top portion 108 and the bottom portion 112 are configured to retain a glass slide therebetween. In various embodiments, the top portion 108 and the bottom portion 112 are formed with registration elements such as bumpers and/or overhangs to repeatedly position to the substrate (e.g., glass slide) between the top and bottom portions. As shown in FIG. 8B, a user can slide an edge of the substrate beneath the overhang to position the substrate within the bottom portion. In various embodiments, the bottom portion 112 has a thin profile for compatibility with one or more other devices, such as compatibility with a thermocycler.

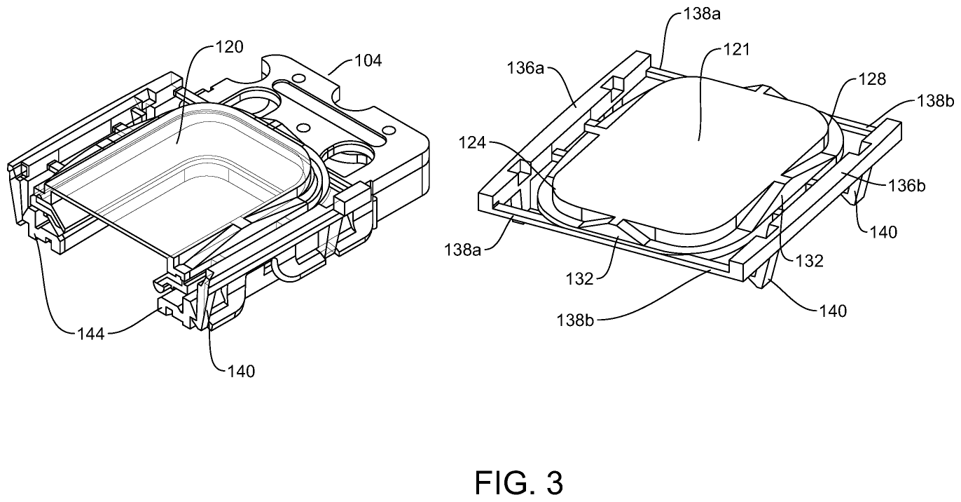

As shown in FIGS. 1-3, the bottom portion 112 includes a plurality of snap joint receiving elements 140. In various embodiments, at least a pair of snap joint receiving elements is arranged on the bottom portion 112 opposite from each other, such that the pair of snap joint receiving elements 144 are disposed on the opposite long sides of the bottom portion 112. In various embodiments, the first and second oppositely-disposed pairs of snap joint elements are configured to align with complementary coupling features shown in this exemplary embodiment snap joint elements 140 disposed on the lid and coupled thereto. In various embodiments, the snap joint receiving elements 144 on the bottom portion 112 of the cassette include one or more resilient members (e.g., a lug, recess, shelf or hook-shaped element) configured to be deflected and return to a rest position coupled with the snap joint elements of the lid. In various embodiments, the top portion 108 of the cassette is cut or designed with windows to provide access to the snap joint receiving elements 144 disposed on the bottom portion 112 to snap joint elements 140 of the lid, as shown in FIG. 3.

With continued reference to FIGS. 1-3, the lid 120 is configured to releasably couple to sample device 104 via a plurality of snap joint elements. In various embodiments, the lid 120 includes a cover 121 having planar outer and inner surfaces. In various embodiments, the planar outer and inner surfaces are spaced from each other, defining a thickness of the cover therebetween. In various embodiments, the thickness of the cover is approximately 0.75 mm−1 mm, although other suitable thicknesses are within the scope of this disclosure. In various embodiments, the lid 120 includes a first side opposite a second side and a third side opposite a fourth side thereby forming a generally rectangular planform shape. In various embodiments, the sides of the lid 120 are parallel. In various embodiments, the sides of the lid 120 are curvilinear. In various embodiments, the first and second sides have a first length, and the third and fourth sides have a second length. In various embodiments, the first and second sides are longer than the third and fourth sides, such that the first length is greater than the second length. In various embodiments, the first and second sides are shorter than the third and fourth sides. In various embodiments, the first and second sides are equal to the third and fourth sides in length, forming a generally square planform lid 120. In various embodiments, the corners of the lid 120 are rounded, with any suitable radius. In various embodiments, the lid 120 is made of at least one of: polyethylene (PE), polyethylene terephthalate (PET), high density PET, polyurethane (PU), polystyrene (PS), polypropylene (PP), polycarbonate (PC), acrylonitrile butadiene styrene (ABS), acetal, acrylic, PEEK, polyvinyl chloride (PVC), polyamide, polyimide, polyamide-imide, fluorinated ethylene propylene (FEP), ethylene tetrafluoroethylene (ETFE), polyphenylene oxide, and/or polyphenylsulfone (PPSU). In various embodiments, the lid 120 is fabricated via injection molding, additive manufacture (e.g., 3D printing) or thermoforming (e.g., vacuum thermoforming).

In various embodiments, the lid 120 includes a skirt 124 extending about a perimeter of the inner surface. In various embodiments, the skirt 124 and the inner surface of the cover 121 define a recess. In various embodiments, the recess is approximately 2 mm measured from inner surface to the end of the skirt 124. In various embodiments, the skirt 124 extends downwardly and substantially perpendicularly from the cover 121, to form the recess. In various embodiments, the skirt 124 extends downwardly at an angle to a vertical axis (e.g., the skirt has a positive draft angle to allow for release from a mold during manufacture). In various embodiments, skirt 124 slopes downwardly from the cover 121 at an angle (e.g., 0.1° 45° relative to a vertical axis), to form a gradually widening recess. In various embodiments, the skirt 124 extends any distance from the cover 121 such that the recess may be of any suitable volume, to accommodate a varying size well 117 or sample within.

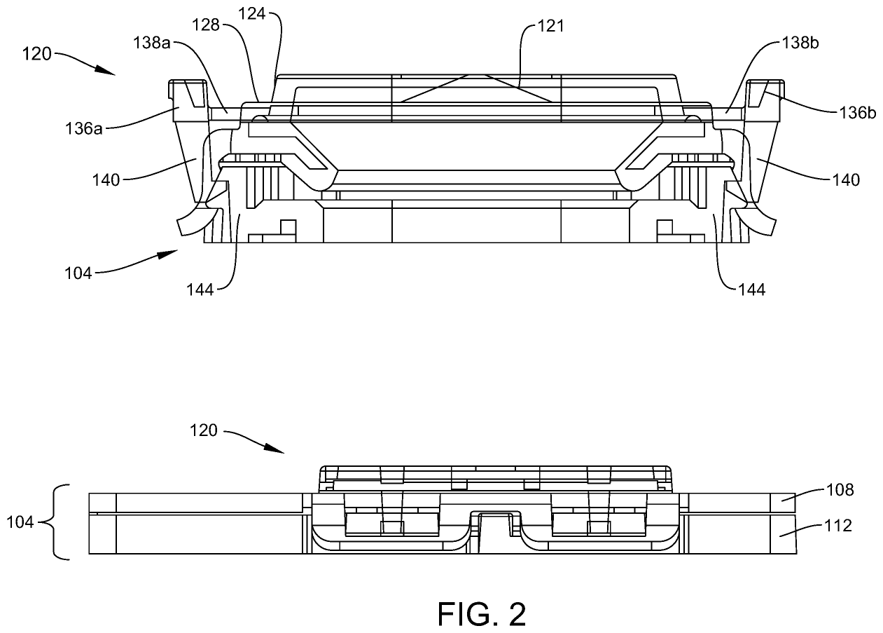

In various embodiments, the lid 120 includes a flange extending from the skirt 124. In various embodiments, the flange 128 is parallel to the planar outer surface of cover 121 (as shown in FIG. 2). That is to say, the flange 128 and the topmost portion of the lid 120 are parallel. In various embodiments, the flange 128 extends radially a predetermined distance, be it equidistantly about the periphery of the skirt 124 or of a varying distance relative to one or more sides. In various embodiments, the flange 128 has rounded corners to match the rounded corners of any one of cover 121 or skirt 124, or both. In various embodiments, the flange 128 extends outwardly from the skirt 124 and downwardly extending forming an upper surface of flange 128 spaced from a lower surface of flange 128 by a flange thickness. In various embodiments, the flange 128 has a constant thickness. In various embodiments, the flange 128 has a variable thickness relative to one or more sides of the lid 120. In various embodiments, the flange 128 has a greater thickness along the first and second sides, proximate the snap joint elements 140.

In various embodiments, the skirt 124 has at least one rib 132 extending between an upper surface of flange 128 to the planar outer surface of cover 121 (as shown in FIG. 3). In various embodiments, the at least one rib 132 includes a triangular shape, wherein a base of the triangle is disposed on the upper surface of the flange 128 and the apex of the triangle is coplanar with the outer (or top) surface of the lid. In various embodiments, the rib(s) can be located such that the apex of the rib 132 coincides with a midpoint of the flange and/or cover side. In various embodiments, each side of lid 120 includes one or more ribs 132. For example, and without limitation, the skirt 124 may include a rib 132 disposed at a midpoint of at least one of the sides, such as the first and second, or third and fourth sides. In various embodiments, multiple ribs 132 are disposed on one or more sides of the lid 120. In the exemplary embodiment shown in FIG. 3, ribs 132 are included on both the shorter and longer sides of the cover. These ribs provide additional strength and rigidity to the lid, thereby reducing likelihood of bowing or buckling of the lid during the various forces and thermal cycling described herein in connection with the biochemical analyses performed on the cassette and lid.

As shown in FIGS. 2, 3, and 9, the flange 128 includes a groove 129 disposed in the lower surface thereof. In various embodiments, the groove 129 is configured to receive at least a portion of the gasket 105, such as the O-ring element 106, when the lid 120 engages with (i.e., contacts) sample device 104. In various embodiments, the groove 129 has a generally rectilinear cross-sectional recess circumscribing the lower surface of flange 128. For example, and without limitation, the groove 129 may have a base and sidewalls. In various embodiments, the sidewalls are oriented at an angle greater than 90 degrees relative to a horizontal. In various embodiments, the sidewalls of groove 129 are configured to accept the O-ring element 106 and account for imperfect coupling of the lid 120 and sample device 104, or manufacturing tolerances thereof. An example cross-sectional shape of groove 129 is shown in FIG. 9. For example, and without limitation, the sidewalls of the groove 129 may be formed at approximately 95 degrees to a generally planar base. In various embodiments, the groove 129 shares the same planform shape as flange 128, thereby having rounded corners joining generally linear sides parallel to the first, second, third and fourth sides of the cover 120. In various embodiments, the groove 129 is shaped with a complimentary profile to receive the O-ring element 106 therein upon coupling the lid to the top portion 108 of the cassette, thereby forming an enhanced seal to reduce or prevent evaporation loss of reagents within the well.

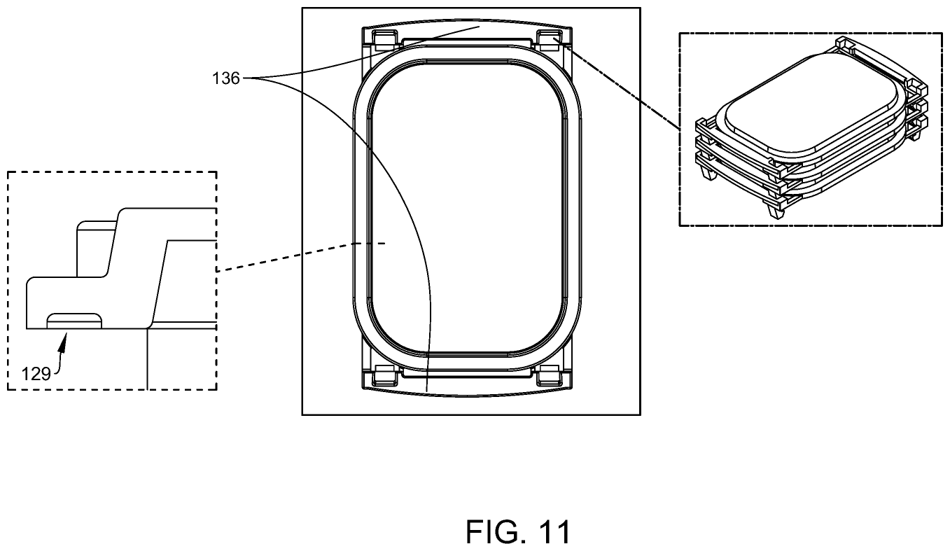

In various embodiments, when the lid 120 is placed on the sample device 104, the flange 128 contacts the periphery of the opening 116 of the well 117. For example, when the lid 120 contacts the top portion 108 of the sample device 104, the flange 128 contacts and remains flush with the outer periphery of the gasket 105, with the O-ring element 106 seated in the groove 129. Further, when the snap joint elements 140 lock with the complimentary snap joint receiving elements 144 disposed on the bottom portion 112 of sample device 104, a seal is formed between the lid 120 and the gasket 105 (e.g., the outer periphery of the opening 116 of the well 117). For example, the snap joint elements 140 of the lid 120 may include cantilevered clips and the snap joint receiving elements 144 of the sample device 104 may include apertures or recesses. In this example, when the lid 120 is placed on the sample device 104 (e.g., the flange 128 of the lid 120 contacts the gasket 105), the cantilevered clips clip into the respective apertures or recesses of the sample device 104 to lock the lid 120 to the sample device 104. Moreover, a sealed chamber is formed in the well 117, defined by the inner surface of the cover of the lid 120 as a ceiling, the substrate as a floor, and the inner surface of the gasket 105 and the inner surface of the skirt 124 of the lid 120 sealed together as a wall. In some aspects, a symmetrical clip design (e.g., as shown in FIG. 11) enables 2-finger clipping of the lid on the sample device.

In various embodiments, the lid 120 includes a first crossbar 136a extending parallel to the first side of the cover 121. In various embodiments, the first crossbar 136a includes a first end and a second end, defining a length therebetween. In various embodiments, the first crossbar 136a extends linearly between the first end and the second end. In various embodiments, the first crossbar 136a includes a constant thickness profile along its length. In various embodiments, the first crossbar 136a includes a thicker thickness profile at a midpoint between the first end and the second end. In various embodiments, the first crossbar 136a may include a thicker thickness profile at the first end and/or the second end. In various embodiments, the first crossbar 136a is coupled to the lid 120 via at least one strut 138a extending radially therefrom. In various embodiments, the strut 138a extends perpendicularly to the first side of cover 121 or at an angle thereto. For example and without limitation, a plurality of struts 138a may extend between the flange 128 and the first crossbar 136a. In various embodiments, at least two struts 138a extend from terminal ends of the first side of flange 128 proximate the third and fourth sides. In various embodiments, the struts 138a are linear or include a profiled cross-sectional shape. In various embodiments, a first strut 138a is disposed proximate a first end of the first crossbar and a second strut disposed proximate a second end of the first crossbar. In various embodiments, each strut extends perpendicularly to the first crossbar 136. In various embodiments, the first crossbar 136a includes an upper surface, each strut includes an upper surface, and the upper surface of first crossbar 136a spaced from the upper surface of the at least one strut 138a.

In various embodiments, the first crossbar 136a includes a first pair of snap joint elements 140. In various embodiments, each snap joint element 140 of the first pair of snap joint elements includes a resilient flexible member configured to move once deflected and return to a rest position after deflection. As shown in the cross section of FIG. 2, the resilient member has a tab portion of snap joint elements 140 that extends downwardly and perpendicularly from the first crossbar 136a. In various embodiments, the resilient member of snap joint elements 140 extends downwardly approximately perpendicular relative to the flange 128. In various embodiments, the resilient member of snap joint elements 140 includes an inwardly extending portion configured to couple with the snap joint receiving elements 144 disposed on the bottom portion 112. For example, and without limitation, the snap joint elements 140 and the snap joint receiving elements 144 may include complementary members configured to engage one another, such as opposite and opposing hook-type members.

In various embodiments, the snap joint receiving elements 144 include a triangular profile to ensure full clipping of the top portion 108 and lid 120. In various embodiments, the triangular profile will result in the snap joint element 140 sliding upward when not fully engaged in order to notify a user of a misalignment of components or half-clipped phenotypes, as shown in FIG. 4B. In various embodiments, snap joint elements 140 are deflected outwardly when engaged with snap joint receiving elements 144 and returned to a rest position once fully engaged as to arrest relative motion of the lid 120 and sample device 104. In various embodiments, the snap joint element, or the tab section is made from a polymer material such as but not limited to a polyphenylsulfone material, a polyethylene material, a polyurethane material, a polyethylene terephthalate material, a polystyrene material, a polycarbonate material, a polypropylene material, or a combination thereof. In various embodiments, the lid, the snap joint element, or the tab section re made from any one or more of the above materials using any suitable manufacturing technique, including but not limited to 3D printing, injection molding, rapid casting, etc.

In various embodiments, the first crossbar 136a includes a pair of snap joint elements 140 aligned with snap joint receiving elements 144 of bottom portion 112. For example and without limitation, the first crossbar 136a includes exactly two snap joint elements 140. In various embodiments, the first crossbar 136a includes any suitable number of snap joint elements 140 aligned with any suitable number of snap joints receiving elements 144 disposed on the bottom portion 112 of sample device 104.

In various embodiments, the lid 120 includes a second crossbar 136b extending parallel to the second side of the cover 121. In various embodiments, the second crossbar 136 includes a first end and a second end, defining a length therebetween. In various embodiments, the second crossbar 136b extends linearly between the first end and the second end of the second crossbar 136b. In various embodiments, the second crossbar 136b includes a constant thickness profile along its length. In various embodiments, the second crossbar 136b includes a thicker thickness profile at a midpoint between the first end and the second end. In various embodiments, the second crossbar 136 includes a thicker thickness profile proximate the first end and/or the second end. In various embodiments, the second crossbar 136b is coupled to the lid 120 via at least one strut 138b extending radially therefrom. In various embodiments, the strut 138b extends perpendicularly to the second side of cover 121 or at an angle thereto. For example and without limitation, a plurality of struts 138b may extend between the flange 128 and the second crossbar 136b. In various embodiments, at least two struts 138b extend from terminal ends of the second side of flange 128 proximate the third and fourth sides. In various embodiments, the struts 138b are linear or include a profiled cross-sectional shape. In various embodiments, a first strut 138b is disposed proximate a first end of the second crossbar and a second strut disposed proximate a second end of the second crossbar. In various embodiments, each strut extends perpendicularly to the second crossbar 136b. In various embodiments, the second crossbar 136b includes an upper surface, each strut includes an upper surface, and the upper surface of second crossbar 136b spaced from the upper surface of the at least one strut 138b.

In various embodiments, the second crossbar 136b includes a second pair of snap joint elements 140. In various embodiments, each snap joint element 140 of the second pair of snap joint elements 140 includes a resilient member configured to move once deflected and return to a rest position after deflection. As shown in the cross section of FIG. 2, the resilient member has a tab portion of snap joint elements 140 that extends downwardly and perpendicularly from the second crossbar 136b. In various embodiments, the resilient member of snap joint elements 140 extends downwardly approximately perpendicular relative to the flange 128. In various embodiments, the resilient member of snap joint elements 140 includes an inwardly extending portion configured to couple with the snap joint receiving elements 144 disposed on the bottom portion 112. For example, and without limitation, the snap joint elements 140 and the snap joint receiving elements 144 may include complementary members configured to engage one another, such as opposite and opposing hook-type members. In various embodiments, the snap joint elements 140 are deflected outwardly when engaged with snap joint receiving elements 144 and returned to a rest position once fully engaged as to arrest relative motion of the lid 120 and sample device 104.

In various embodiments, the second crossbar 136b includes a pair of snap joint elements 140 aligned with snap joint receiving elements 144 of bottom portion 112. For example and without limitation, the second crossbar 136b includes exactly two snap joint elements 140 disposed on the second crossbar 136. In various embodiments, the second crossbar 136b includes any suitable number of snap joint elements 140 aligned with any suitable number of snap joint receiving elements 144 disposed on the bottom portion 112 of sample device 104.

In the exemplary embodiment shown in FIG. 3, four struts 138a, 138b are included on each (long) side of the lid 120, one strut at each terminus of the first crossbar 136a and the second cross bar 136b, and two equidistantly spaced therebetween (with the two inner struts disposed on each side of the rib 132). In an alternative embodiment, shown in FIG. 1C, the cross bars are disposed on the shorter sides of the lid, with two struts connecting the cross bars to the lid flange (each strut at a terminus of the cross bar). The cross bars are sufficiently rigid to permit a user to press down on the crossbar (at any location along its length), with the load being distributed and delivered such that the snap joint elements on the cross bar depress and flex to engage the bottom of the cassette (as shown by the arrows in FIG. 5). This force distribution via the cross bars and clips allows a user to quickly handle and attach the lid, while ensuring a sufficient seal is formed between the lid, gasket, and well of the device.

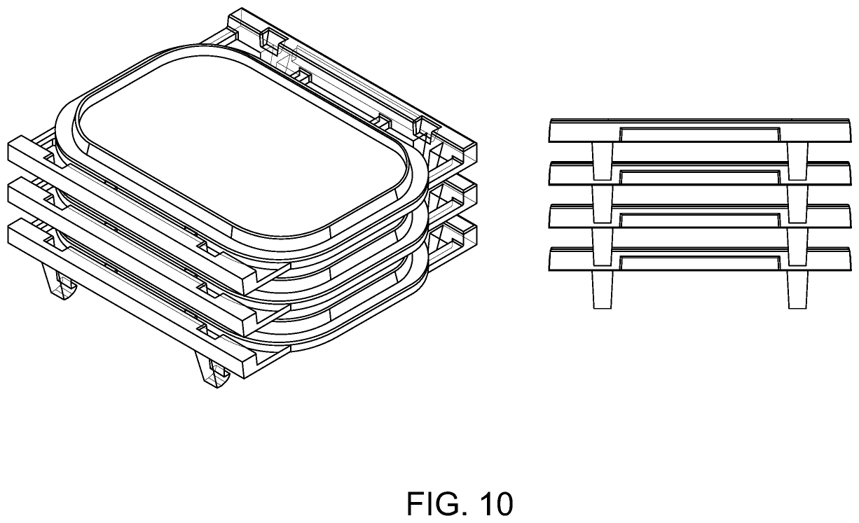

In accordance with another aspect of the present disclosure, lid 120 may be configured to stack together with a plurality of other lids 120. For example, and without limitation, the lid 120 may include a plurality of receiving elements (e.g., notches, grooves) on a first side, such as a lower side of the lid, said receiving elements configured to receive a complementary plurality of protrusions (e.g., first and second snap joints) extending form the upper side of an adjacent lid 120. For example, and without limitation, a plurality of lids 120 may be stored in a stacked arrangement, aligned with one another in said stack, as shown in FIG. 10. The receiving elements can be located on the cross bars and/or flange structures of each lid. In some aspects, storing the lids in a stacked arrangement prevents scratching of the lids.

As shown in FIG. 5, coupling the first and second pair of snap joint elements 140 with the first and second pair of snap joint receiving elements 144 along the first and second (longer) sides of the lid 120 and sample device 104 (see bottom embodiment of FIG. 5) as opposed to the third and fourth sides (the shorter sides, as shown in top embodiment of FIG. 5) may provide advantages in that sealing between the lid 120 and gasket 105 (and/or sample device 104) is improved. By coupling the lid 120 and sample device 104 on the relatively longer sides, the bowing of the lid 120 and the sample device 104 are substantially matched. In contrast, coupling the lid 120 along the shorter sides causes the lid 120 to bow in an opposite direction relative to the sample device 104 and/or gasket 105, which may cause the seal between the lid 120 and the sample device 104 to be less secure. For example, and without limitation, as can be seen in the upper portion of FIG. 5, if the snap joint elements 140 are disposed on the third and fourth sides of lid 120, the lid 120 bows along an axis parallel to said third and fourth sides. In this configuration, the gasket 105 and/or sample device 140 bows along both a parallel axis and a perpendicular axis to the third and fourth sides. In other words, the lid deflects upwardly along the long edges, and the gasket deflects both: i) downwardly along the same long edges, and ii) upwardly along the short edges. Additionally, bowing along the parallel axis is in an opposite direction as the lid, such that the central portion of the lid and the central portion of the sample device bow away from one another, which may cause the seal formed therebetween to be less secure, thereby allowing for some evaporative loss. When the snap joint elements are arranged along the first and second (longer) sides of lid 120, the lid 120 and sample device 104 bow along an axis parallel to the first and second sides, but in the same direction. As shown in the exaggerated sealing surface profiles in FIG. 5, the seal is maintained despite the bowing of the components. The lid 120 disclosed herein maintains a sufficient seal during elevated pressures within the well that are endured during incubation, e.g., up to about 3 psi.

In various embodiments, an assembly 100 (as shown throughout the figures, and specifically in FIGS. 6B-6C, may be positioned on an adapter plate 604 configured to secure the assembly 100 thereon. In various embodiments, the adapter plate 604 is configured to receive two or more assemblies, as shown in FIG. 6B. In various embodiments, the adapter plate 604 is a thermocycler adapter plate having one or more sets of raised portions 606a, 606b, 606c that correspond to apertures formed in the bottom portion 112 of the sample device 104. In various embodiments, the adapter plate 604 includes two sets of raised portions so that a user can secure up to two assemblies 100 on the adapter plate 604 (shown in FIGS. 6A-6D). These raised portions 606a, 606b, 606c are shown in FIG. 6C with a complimentary geometry to the recesses or openings in the bottom of the sample device 104, so that a user can securely attached the sample device(s) 104 (e.g., cassette) to the adaptor with an interference fit that prevents movement of the cassettes relative to the adaptor 604. In various embodiments, the adapter plate 604 includes a plurality of elongated posts 610 (e.g., six posts) disposed about the periphery of the adapter plate 604. In various embodiments, the elongated posts 610 are disposed at the corners of the adapter plate. In various embodiments, the elongated posts 610 are disposed at the midpoints of one or more edges of the adapter plate 604. In various embodiments, the elongated posts 610 function to prevent a thermocycler lid from closing too far downward over the assembly 100, thereby providing excessive force on the lid 120. In various embodiments, the adaptor 604 includes a plurality of legs 608. In various embodiments, the plurality of legs extend downwardly. In various embodiments, the plurality of legs 608 are equally-distributed about the bottom surface of the adaptor. In various embodiments, the plurality of legs 608 serve as a stacking feature for placement of the adaptor 604 within an apparatus (e.g., thermocycler) employed during sample preparation. In various embodiments, the plurality of legs 608 serve as a pedestal to raise the base of the adaptor 604, and thus assemblies 100 disposed thereon, to permit air flow under the adaptor.

In various embodiments, the adapter plate 604 is sized to position two assemblies 100 side-by-side thereon. In various embodiments, the adapter plate 604 is generally rectangular and has radiused corners.

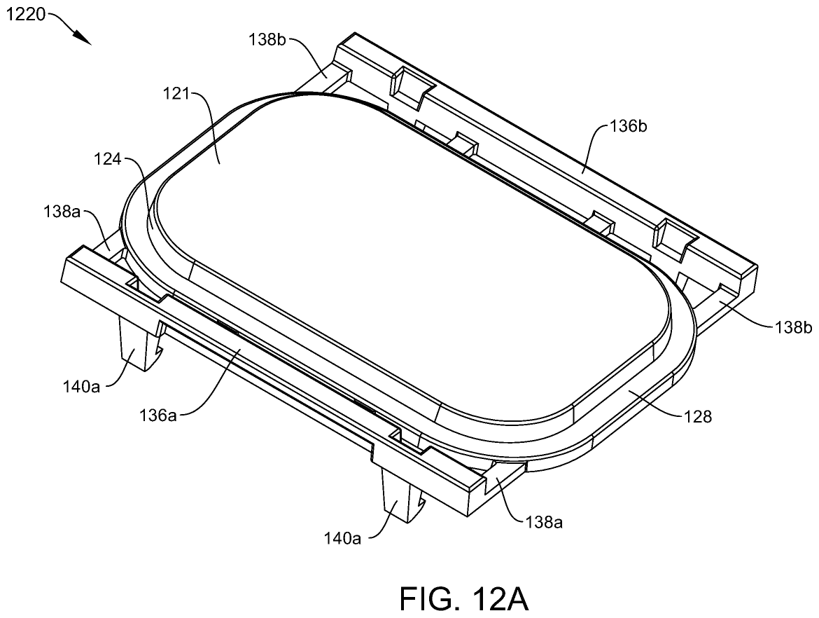

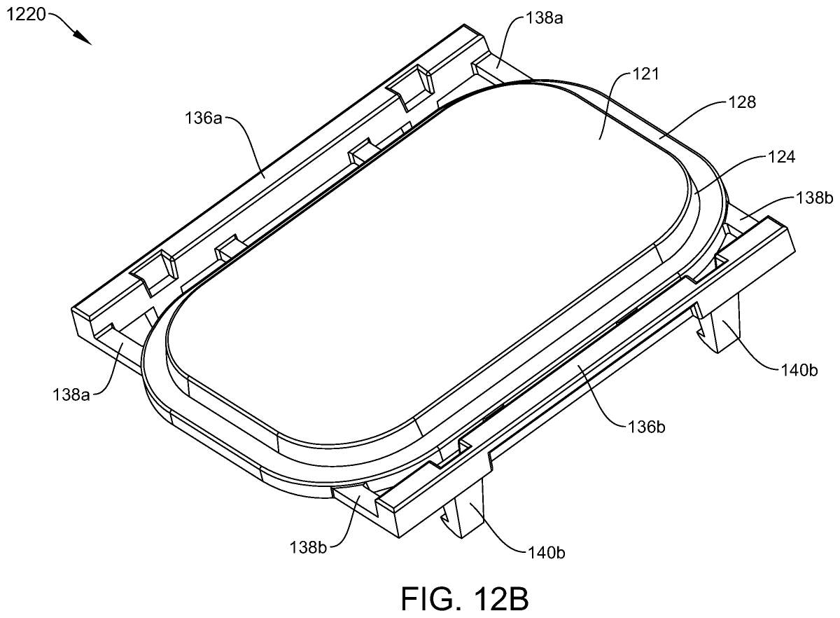

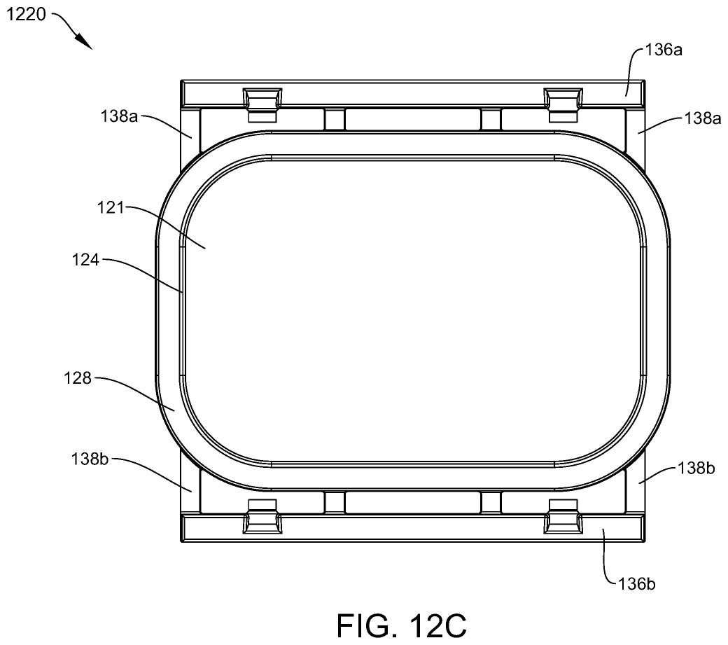

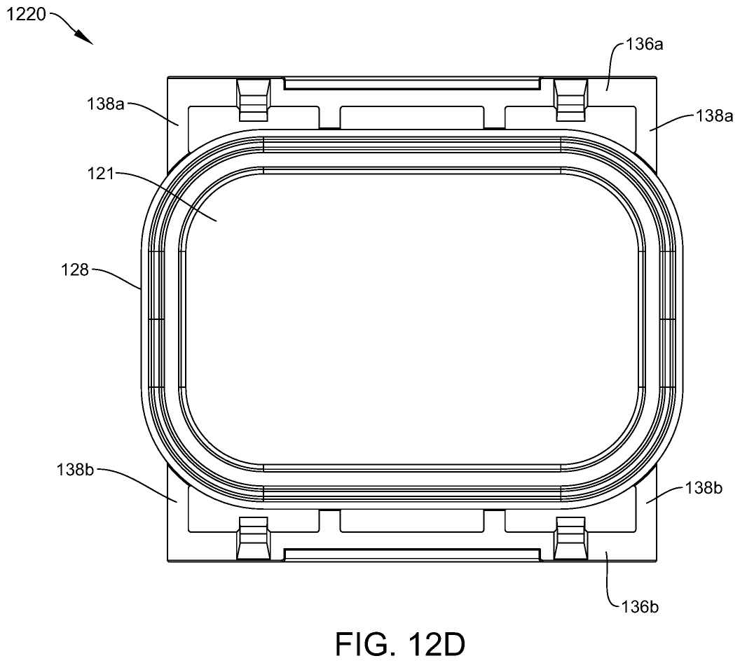

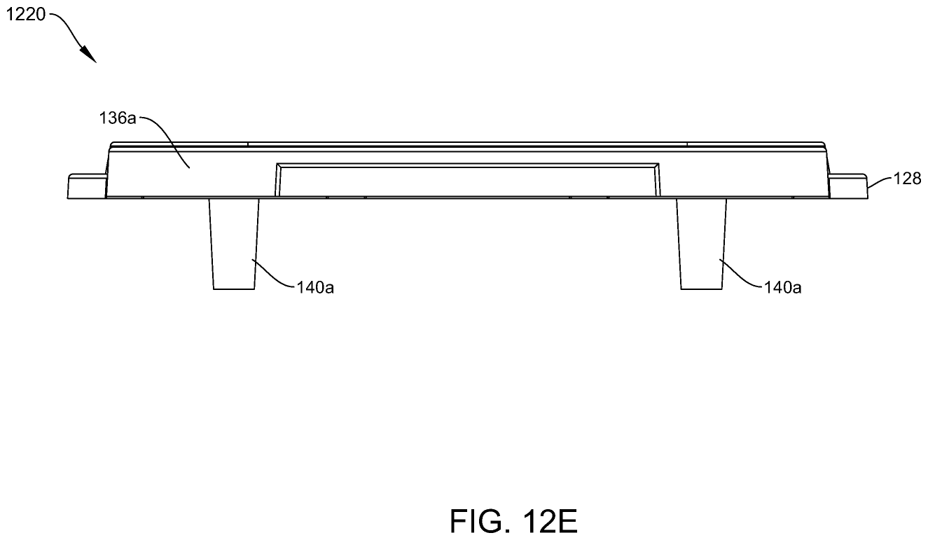

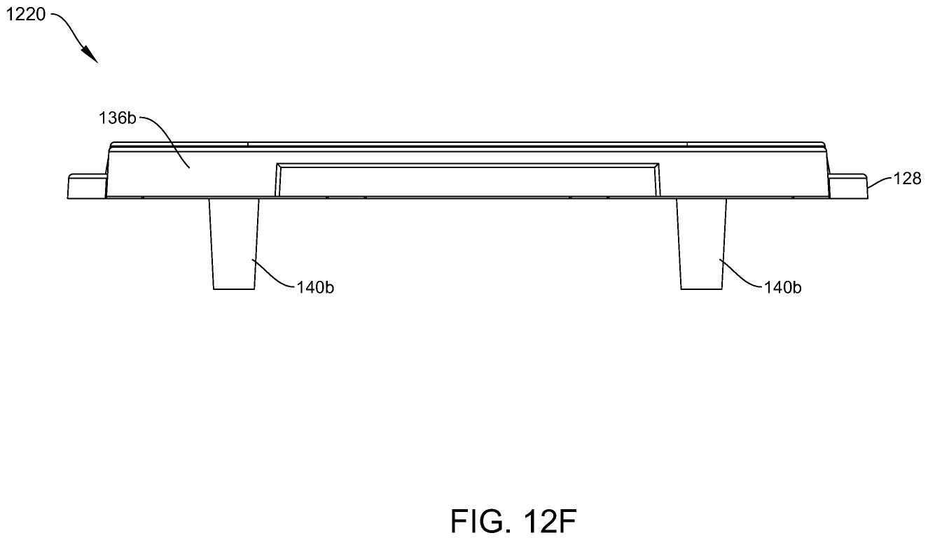

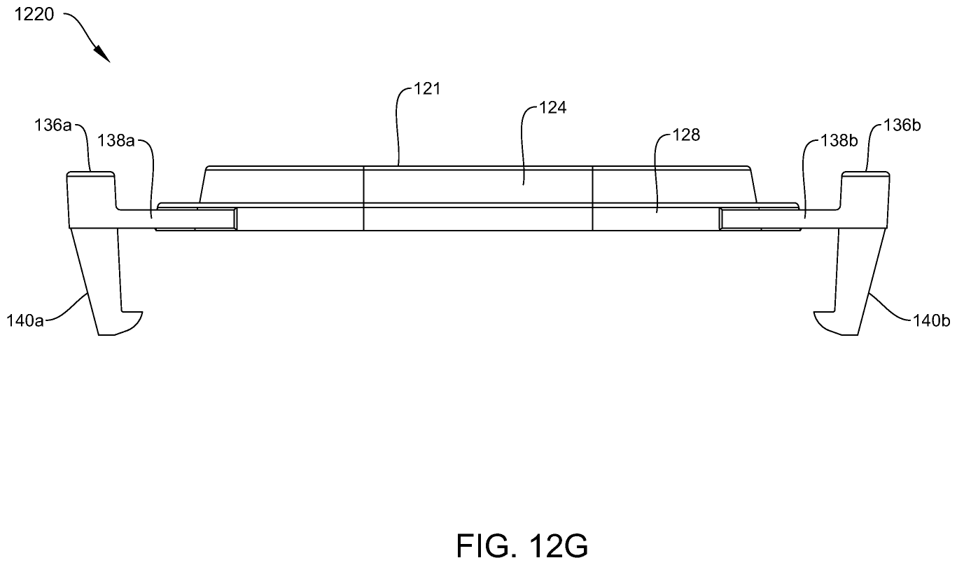

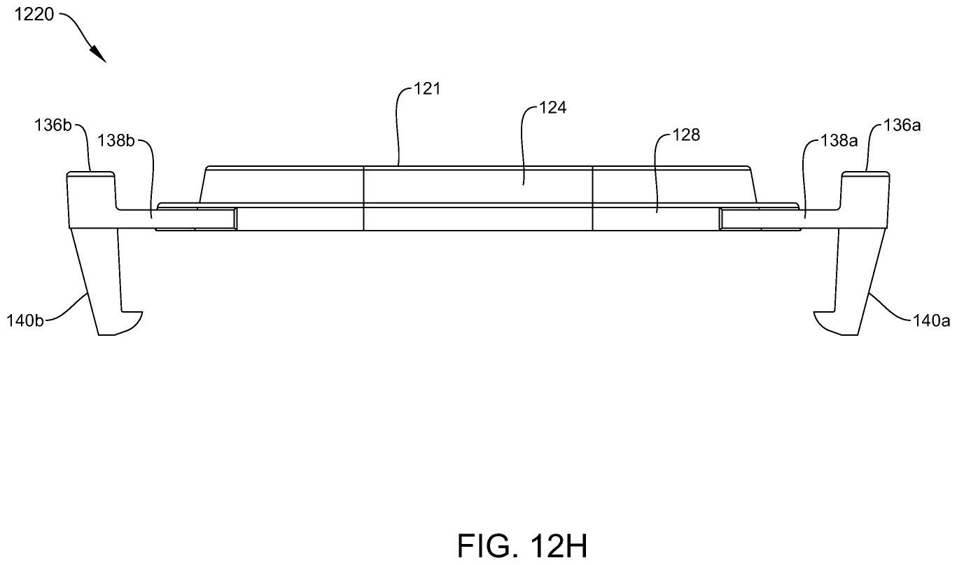

FIGS. 12A-12H are various views of a stackable lid 1220. As shown in FIGS. 12A-12H, the stackable lid 1220 is similar to stackable lid 120. The lid 1220 is configured to cover and seal an open well flow cell of a sample device (e.g., sample device 104). In various embodiments, the lid 1220 includes a cover 121 having a planar outer surface and an inner surface. In various embodiments, the planar outer surface and inner surface are spaced from each other, defining a thickness of the cover therebetween. In various embodiments, the lid 1220 includes a cover 121 having multiple sides. In various embodiments, the lid 1220 includes a first side opposite a second side and a third side opposite a fourth side thereby forming a generally rectangular planform shape. In various embodiments, the sides of the lid 1220 are parallel. In various embodiments, the sides of the lid 1220 are curvilinear. In various embodiments, the first side and the second side each have a first length and the third side and fourth side each have a second length, with the first length greater than the second length.

In various embodiments, the lid 1220 includes a skirt 124 extending about a perimeter of the inner surface. In various embodiments, the skirt 124 and the inner surface of the cover 121 define a recess. In various embodiments, the lid 1220 includes a flange extending from the skirt 124. In various embodiments, the flange 128 is parallel to the planar outer surface of cover 121 (e.g., as shown in FIGS. 12G and 12H). In various embodiments, the lower surface of the flange 128 is planar. In various embodiments, the lower surface of the flange 128 includes a groove (e.g., groove 129) configured to receive at least a portion of a gasket (e.g., gasket 105) when the lid 1220 engages with a sample device (e.g., sample device 104).

In various embodiments, the lid 1220 includes a first crossbar extending parallel to the first side of the cover 121. In various embodiments, the first crossbar 136a includes a first pair of snap joint elements 140a. In various embodiments, the lid 1220 includes a second crossbar 136b extending parallel to the second side of the cover 121. In various embodiments, the second crossbar 136b includes a second pair of snap joint elements 140b.

In various embodiments, the lid 1220 includes multiple struts (e.g., 2 struts, 3 struts, 4 struts) connecting the first crossbar 136a to the flange 128. In various embodiments, the lid 1220 includes multiple struts (e.g., 2 struts, 3 struts, 4 struts) connecting the second crossbar 136b to the flange 128. In the exemplary embodiment shown in FIGS. 12A-12H, four struts 138a, 138b are included on each (long) side of the lid 1220, one strut at each of the ends of the first crossbar 136a and the second crossbar 136b, and two struts equidistantly spaced therebetween.

The lid 1220 may be configured to stack together with a plurality of other lids 1220. For example, and without limitation, the lid 1220 may include a plurality of receiving elements (e.g., notches, grooves) on the upper side of the lid, said receiving elements configured to receive a complementary plurality of protrusions (e.g., the first and second snap joints) extending from the lower side of an adjacent lid 1220. For example, and without limitation, a plurality of lids 1220 may be stored in a stacked arrangement, aligned with one another in said stack. The receiving elements can be located on the cross bars (e.g., as shown in FIGS. 12A and 12B) and/or flange structures of each lid.

In various embodiments, the lid (e.g., lid 1220, 120) is configured to snap over the open well and form a seal against a gasket. In various embodiments, the lid is configured to couple to the cassette (e.g., sample device), such as through resilient latches configured to snap over a geometric feature or boss of the cassette. In various embodiments, the lid is configured to couple to the cassette over the well. In various embodiments, the lid is configured to hingedly couple to the cassette. In various embodiments, the lid is coupled to the cassette via one or more mechanical fasteners. In various embodiments, the lid is coupled to the cassette via magnets. In various embodiments, the lid is formed as a unitary component with the cassette.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A lid for forming a sealed fluidic chamber, the lid comprising:
a cover including:
a first side opposite a second side and a third side opposite a fourth side, wherein the first side and the second side each have a first length and the third side and the fourth side each have a second length, wherein the first length is greater than the second length;
a planar outer surface; and
an inner surface separated from the planar outer surface by a thickness of the cover;
a skirt extending about a perimeter of the inner surface, the skirt and the inner surface define a recess;
a flange extending about a perimeter of the skirt, the flange disposed parallel to the planar outer surface;
a first crossbar, at least a portion of the first cross bar extending parallel to the first side of the cover, the first crossbar having a first pair of snap joint elements;
a second cross bar, at least a portion of the second cross bar extending parallel to the second side of the cover, the second crossbar having a second pair of snap joint elements; and
at least one strut connecting at least one crossbar to the flange.

2. The lid of claim 1, wherein the at least one strut includes a first strut disposed proximate a first end of the first crossbar and a second strut disposed proximate a second end of the first crossbar, each strut extending perpendicularly to the crossbar.

3. The lid of claim 1, wherein each crossbar includes an upper surface and each strut includes an upper surface, the upper surface of at least one crossbar spaced from the upper surface of at least one strut.

4. The lid of claim 1, wherein the snap joint elements extend perpendicularly to the flange.

5. The lid of claim 1, wherein the snap joint elements comprise a resilient member configured to move once deflected and return to a rest position after deflection.

6. The lid of claim 1, wherein the skirt includes at least one rib extending between an upper surface of the flange to the planar outer surface.

7. The lid of claim 6, wherein the skirt includes a rib disposed at a midpoint of at least one of the third or fourth sides.

8. The lid of claim 1, wherein each of the snap joint elements comprises a tab portion extending perpendicularly from the crossbar.

9. An assembly, comprising:
a sample device including:
a bottom portion and a top portion, wherein:
the bottom portion is releasably coupled to the top portion;
a gap is formed between the bottom portion and the top portion when the bottom portion is coupled to the top portion, the gap configured to receive a sample substrate; and
the top portion including a well;
the bottom portion including a plurality of snap joint receiving elements, at least a pair of the plurality of snap joint receiving elements arranged on the bottom portion substantially opposite from each other; and
a lid including:
a first side opposite a second side and a third side opposite a fourth side, wherein the first side and the second side each have a first length and the third side and the fourth side each have a second length, wherein the first length is greater than the second length;
a planar outer surface; and
an inner surface separated from the planar outer surface by a thickness;
a skirt extending about a perimeter of the inner surface, the skirt and the inner surface define a recess;
a flange extending about a perimeter of the skirt, the flange disposed parallel to the planar outer surface;
a first crossbar extending parallel to the first side of the cover, the first cross bar having a first pair of snap joint elements;
a second cross bar extending parallel to the second side of the cover, the second cross bar having a second pair of snap joint elements;
wherein when the lid engages with the sample device, the first and second pair of snap joint elements engage with a plurality of corresponding snap joint receiving elements to form a seal between the lid and a periphery of the well of the top portion.

10. The assembly of claim 9, further comprising a gasket disposed around the periphery of the well, wherein when the lid engages with the sample device, the gasket couples with a periphery of the flange to form a seal.

11. The assembly of claim 10, wherein a sealed chamber is defined by the sample substrate, the gasket and the lid.

12. The assembly of claim 9, wherein the gasket comprises an angled inner surface.

13. The assembly of claim 9, wherein the first side and the second side of the lid are longer than the third side and the fourth side of the lid.

14. The assembly of claim 13, wherein the plurality of snap joint receiving elements are disposed along a first and a second side of the bottom portion, the first side of the bottom portion aligned with the first side of the lid and the second side of the bottom portion aligned with the second side of the lid.

15. The assembly of claim 10, wherein cover flange includes a groove, the groove configured to receive at least a portion of the gasket.

16. The assembly of claim 15, wherein the groove includes a base and sidewalls, the sidewalls oriented at an angle greater than 90 degrees relative to the base.

17. The assembly of claim 15, wherein the groove has radiused corners.

18. The assembly of claim 9, wherein the top portion of the sample device includes a plurality of apertures, each of the snap joint elements of the cover configured to extend through an aperture.

19. The assembly of claim 9, further comprising an adaptor configured to receive at least one sample device and lid; the adaptor including a plurality of surface features on an upper surface thereof configured to engage the bottom of the at least one sample device.

20. The assembly of claim 19, wherein the adaptor includes at least one upwardly extending protrusion configured to abut the lid, limiting downward displacement of the lid.
